(19) United States
(12) Patent Application Publication
(10) Pub. No.: US 2025/0215120 A1
(43) Pub. Date: Jul. 3, 2025

(54) POLYETHYLENE POWDER AND METHOD FOR PRODUCING SAME, AND CATALYST FOR OLEFIN POLYMERIZATION AND METHOD FOR PRODUCING SAME

(71) Applicant: ASAHI KASEI KABUSHIKI KAISHA, Tokyo (JP)

(72) Inventors: Naoya Okitsu, Tokyo (JP); Keisuke Hirami, Tokyo (JP); Masahide Uomi, Tokyo (JP); Akio Fujiwara, Tokyo (JP); Makoto Okamoto, Tokyo (JP); Kenji Ebara, Tokyo (JP); Ayano Kitamura, Tokyo (JP)

(73) Assignee: ASAHI KASEI KABUSHIKI KAISHA, Tokyo (JP)

(21) Appl. No.: 18/852,537

(22) PCT Filed: Mar. 31, 2023
(86) PCT No.: PCT/JP2023/013646

§ 371 Date: Sep. 30, 2024

(30) Foreign Application Priority Data
Mar. 31, 2022 (JP) 2022-059266

(51) Int. Cl. C08F 10/02; C08F 4/659; C08F 4/6592; H01M 50/417; H01M 50/489

(52) U.S. Cl. CPC C08F 10/02; C08F 4/65912; C08F 4/6592; H01M 50/417; H01M 50/489; C08F 2500/26

(57) ABSTRACT

A polyethylene powder
having a viscosity-average molecular weight of 100,000 or larger and 4,000,000 or smaller, and
having a crystal thickness parameter of 5° C. or higher and 9° C. or lower obtained from measurement using a differential scanning calorimeter (DSC).

### TECHNICAL FIELD

The present invention relates to a polyethylene powder and a method for producing the same, and a catalyst for olefin polymerization and a method for producing the same.

### BACKGROUND ART

Ethylene polymers are used for a wide variety of purposes such as films, sheets, microporous membranes, fibers, foams, and pipes. The ethylene polymers are used because melt processing is easy and the obtained molded article has high mechanical strength and is also excellent in chemical resistance, rigidity, etc. Among others, ultrahigh-molecular-weight ethylene polymers have higher mechanical strength and are excellent in slidability and abrasion resistance and also excellent in chemical stability and long-term reliability, because of high molecular weight. In this respect, ultrahigh-molecular-weight polyethylene powders are used particularly as starting materials for microporous membranes for separators of secondary batteries typified by lead storage batteries or lithium ion batteries.

Various ethylene polymers having improved characteristics have been proposed as starting materials for microporous membranes for secondary battery separators or the like. For example, Patent Document 1 has proposed an ethylenic polymer that can provide a molded article (e.g., a drawn molded article and a microporous membrane) excellent in oxidation resistance and shrinkage resistance, wherein an intrinsic viscosity falls within a predetermined range, and a specific ratio of heat of fusion obtained under specific measurement conditions of a differential scanning calorimeter (DSC) is equal to or less than a specific lower limit value. For example, Patent Document 2 has proposed a method for producing a supported metallocene catalyst that can produce a polyolefin polymer having an improved apparent polymer density while characteristics of a highly active catalyst are maintained, and a method for producing polyolefin using this catalyst.

### LIST OF PRIOR ART DOCUMENTS

### Patent Document

Patent Document 1: Japanese Patent No. 6383479
Patent Document 2: Japanese Translation of PCT International Application Publication No. 2017-518423

### SUMMARY OF INVENTION

### Problems to be Solved by Invention

Levels required for microporous membranes for secondary battery separators have been increasing rapidly in recent years, and there has been a demand for higher levels of physical properties of polyethylene. Specifically, there has been a demand for polyethylene that can provide a microporous membrane excellent in heat resistance, membrane homogeneity, dimensional stability, and a rate of enhancement in heat resistance, for example. Polyethylene described in each of Patent Documents 1 and 2 is susceptible to improvement in such physical properties.

The present invention has been made in light of these circumstances, and an object of the present invention is to provide a polyethylene powder excellent in heat resistance, membrane homogeneity, dimensional stability, and a rate of enhancement in heat resistance in the form of a microporous membrane.

### Means for Solving Problems

The present inventors have pursued diligent studies to attain the object and consequently completed the present invention by finding that a polyethylene powder having a predetermined viscosity-average molecular weight can provide a microporous membrane excellent in heat resistance, membrane homogeneity, dimensional stability, and a rate of enhancement in heat resistance by controlling predetermined physical properties within specific ranges.

Specifically, the present invention is as follows.

[1]

A polyethylene powder
having a viscosity-average molecular weight of 100,000 or larger and 4,000,000 or smaller, and
having a crystal thickness parameter of 5° C. or higher and 9° C. or lower obtained from measurement using a differential scanning calorimeter (DSC).
   [2]

The polyethylene powder according to [1], wherein a value of z-average shrinkage factor g_{z} measured using a gel permeation chromatography (GPC) measurement apparatus combined with a differential refractometer and a viscosity detector is 0.600 or more and 1 or less.

[3]

The polyethylene powder according to [1], wherein a peak top temperature (Tm2ₜₒₚ) in a DSC curve of a second heating process obtained by measurement shown in the following <Measurement conditions> using a differential scanning calorimeter (DSC) is 135° C. or higher and 140° C. or lower:

### <Measurement Conditions>

(1) left standing at 50° C. for 1 min,
(2) heated from 50° C. to 180° C. at 10° C./min (first heating process),
(3) left standing at 180° C. for 5 min,
(4) cooled from 180° C. to 50° C. at 10° C./min,
(5) left standing at 50° C. for 5 min, and
(6) heated from 50° C. to 180° C. at 10° C./min (second heating process), and
   the crystal thickness parameter is 6.7° C. or higher and 9.0° C. or lower.
      [4]

The polyethylene powder according to any of [1] to [3], wherein the polyethylene powder is drawable under the following conditions:

### (Drawing Conditions)

a 100 mm×100 mm×1 mm thick gel sheet made of 30% by mass of the polyethylene powder and 70% by mass of liquid paraffin is drawn at a ratio of 7×7 at 115° C.
   [5]

The polyethylene powder according to any of [1] to [4], wherein an absorption coefficient at 400 cm⁻¹ to 450 cm⁻¹ in terahertz measurement is 1.0 or more and 4.0 or less.

[6]

The polyethylene powder according to any of [1] to [5], wherein no peak is present in the following regions in ¹H-NMR measurement:
(1) 4.8 ppm to 5.0 ppm, and
(2) 5.6 ppm to 6.0 ppm.
   [7]

The polyethylene powder according to any of [1] to [6], wherein an aluminum content is 0 ppm or more and 50 ppm or less.

[8]

The polyethylene powder according to any of [1] to [7], wherein a silicon content is 0 ppm or more and 30 ppm or less.

[9]

The polyethylene powder according to [1] or [2], wherein a peak top temperature in a DSC curve of a second heating process in differential scanning calorimeter (DSC) measurement is 130° C. or higher and 140° C. or lower.

[10]

The polyethylene powder according to any of [1] to [9], wherein a density is 920 kg/m³ or more and 960 kg/m³ or less.

[11]

The polyethylene powder according to any of [1] to [10] for a battery separator.

[12]

A method for producing a catalyst for olefin polymerization, comprising:
a first supporting reaction step of reacting a solid particle [A] with a transition metal compound component [B-1] and/or a transition metal compound component [B-2] and an activating agent [C] and/or an organic metal compound component [D]; and
a second supporting reaction step of reacting the particle obtained in the first supporting reaction step with the transition metal compound component [B-1] and/or the transition metal compound component [B-2] and the activating agent [C] and/or the organic metal compound component [D], wherein
the transition metal compound component [B-1] is a compound represented by the following (Formula 3), the transition metal compound component [B-2] is a compound represented by the following (Formula 4), the activating agent [C] is a compound represented by the following (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table, and the following <Condition 1> and/or <Condition 2> is satisfied:

### <Condition 1>

the first supporting reaction step comprises: a premixing step of reacting the transition metal compound component [B-1] and/or the transition metal compound component [B-2] with the activating agent [C] and/or the organic metal compound component [D]; and the step of reacting the solid particle [A] with the mixture obtained in the premixing step,

### <Condition 2>

in the first supporting reaction step, a molar ratio (([C]+[D])/[B]) of a molar quantity ([C]+[D]) of the activating agent [C] and the organic metal compound component [D] to a molar quantity [B] of the transition metal compound component [B-1] and/or the transition metal compound component [B-2] is 1 or more and 60 or less,

L¹ⱼWₖM¹X¹ₚX²_{q} (Formula 3)

wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3, or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic σ-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2,

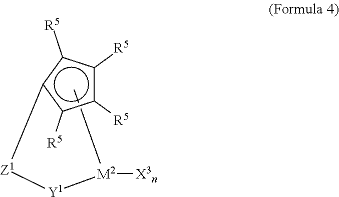

wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,

(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d,

(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.
   [13]

The method for producing a catalyst for olefin polymerization according to [12], wherein the solid particle [A] is a magnesium chloride particle.

[14]

A catalyst for olefin polymerization, comprising
a solid particle [A], a transition metal compound component [B-1] and/or a transition metal compound component [B-2], and an activating agent [C] and/or an organic metal compound component [D], wherein
the transition metal compound component [B-1] is a compound represented by the following (Formula 3), the transition metal compound component [B-2] is a compound represented by the following (Formula 4), the activating agent [C] is a compound represented by the following (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table,
a content (mol) of a central metal M contained in the transition metal compound component [B-1] and/or the transition metal compound component [B-2] is 20 μmol or more and 1000 μmol or less, and a molar ratio (Al/M) of a content (mol) of Al to the content (mol) of the central metal M is 1 or more and 30 or less:

L¹ⱼWₖM¹X¹ₚX²_{q} (Formula 3)

wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3 or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic 6-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2,

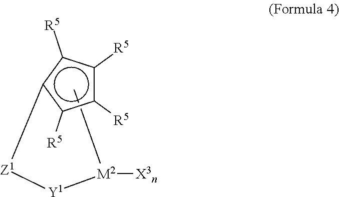

wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,

(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d,

(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.
   [15]

The catalyst for olefin polymerization according to [14], wherein the solid particle [A] is a magnesium chloride particle.

[16]

A method for producing an olefin polymer, comprising the step of polymerizing olefin using the catalyst for olefin polymerization according to [14] or [15].

### Advantages of Invention

The polyethylene powder of the present invention can provide a microporous membrane excellent in heat resistance, membrane homogeneity, dimensional stability, and a rate of enhancement in heat resistance, for example.

### MODE FOR CARRYING OUT INVENTION

Hereinafter, the mode for carrying out the present invention (hereinafter, also referred to as the “present embodiment”) will be described in detail. The present invention is not limited by the present embodiment and can be carried out through various changes or modifications made without departing from the spirit of the present invention.

### [Polyethylene Powder]

The polyethylene powder of the present embodiment
has a viscosity-average molecular weight of 100,000 or larger and 4,000,000 or smaller, and
has a crystal thickness parameter of 5° C. or higher and 9° C. or lower obtained from measurement using a differential scanning calorimeter (DSC).

The polyethylene powder of the present embodiment has these features and can thereby provide a microporous membrane excellent in heat resistance, membrane homogeneity, dimensional stability, and a rate of enhancement in heat resistance.

In the polyethylene powder of the present embodiment, a value of z-average shrinkage factor g_{z} (hereinafter, also referred to as an “average shrinkage factor g_{z}”) measured using a gel permeation chromatography (GPC) measurement apparatus combined with a differential refractometer and a viscosity detector is preferably 0.600 or more and 1 or less.

The polyethylene powder of the present embodiment has these features and can thereby provide a microporous membrane having much better heat resistance, membrane homogeneity, dimensional stability, and rate of enhancement in heat resistance.

The crystal thickness parameter is a difference (Tm2_{end}−Tm2ₜₒₚ) between a peak top temperature (Tm2ₜₒₚ) and a peak convergence point temperature (Tm2_{end}) in a DSC curve of a second heating process obtained by measurement shown in the following <Measurement conditions> (hereinafter, also referred to as a “temperature difference (Tm2_{end}−Tm2ₜₒₚ) in the DSC curve”):

### <Measurement Conditions>

(1) left standing at 50° C. for 1 min,
(2) heated from 50° C. to 180° C. at 10° C./min (first heating process),
(3) left standing at 180° C. for 5 min,
(4) cooled from 180° C. to 50° C. at 10° C./min,
(5) left standing at 50° C. for 5 min, and
(6) heated from 50° C. to 180° C. at 10° C./min (second heating process).

In the polyethylene powder of the present embodiment, preferably, a peak top temperature (Tm2ₜₒₚ) in a DSC curve of a second heating process obtained by measurement shown in the following <Measurement conditions> using a differential scanning calorimeter (DSC) is 135° C. or higher and 140° C. or lower:

### <Measurement Conditions>

(1) left standing at 50° C. for 1 min,
(2) heated from 50° C. to 180° C. at 10° C./min (first heating process),
(3) left standing at 180° C. for 5 min,
(4) cooled from 180° C. to 50° C. at 10° C./min, (5) left standing at 50° C. for 5 min, and
(6) heated from 50° C. to 180° C. at 10° C./min (second heating process), and
the crystal thickness parameter is 6.7° C. or higher and 9.0° C. or lower.

The polyethylene powder of the present embodiment has these features and can thereby provide a microporous membrane having much better heat resistance, membrane homogeneity, dimensional stability, and rate of enhancement in heat resistance.

Although the mechanism under which the polyethylene powder of the present embodiment exerts the effects as mentioned above is not clear, the present inventors have made the following presumption: the DSC curve of the second heating process obtained by measurement shown in the above <Measurement conditions> using a differential scanning calorimeter (DSC) exhibits features of crystals formed in a recrystallization process of the polyethylene powder. The features of such crystals specifically correspond to features of crystals formed in a cooling process after melt kneading of the polyethylene powder in actual steps of producing a microporous membrane, for example. The features of the crystals thus formed presumably influence the physical properties of the microporous membrane. Also, the temperature difference (Tm2_{end}−Tm2ₜₒₚ) in the DSC curve that falls within the above range presumably indicates that a high-melting polyethylene component is contained, i.e., a thick grown crystal moiety is present. In the process in which the crystal moiety is thick grown, it is predicted that a region with low mobility restrained at one end, such as long-chain branching, first starts to be crystallized in a cooling process, and then, crystallization further progresses with this region with low mobility as a core so that the thickness of the crystal moiety is locally increased. The polyethylene powder of the present embodiment can provide a microporous membrane excellent in heat resistance, membrane homogeneity, dimensional stability, and a rate of enhancement in heat resistance, presumably, partly because such a crystal moiety is formed in a recrystallization process.

### (Viscosity-Average Molecular Weight)

The viscosity-average molecular weight of the polyethylene powder of the present embodiment is preferably 200,000 or larger and 4,000,000 or smaller, more preferably 250,000 or larger and 3,000,000 or smaller, further preferably 300,000 or larger and 2,500,000 or smaller. When the viscosity-average molecular weight is equal to or more than the lower limit value, the polyethylene powder of the present embodiment tends to have sufficient mechanical strength in the form of a microporous membrane. When the viscosity-average molecular weight is equal to or less than the upper limit value, the polyethylene powder of the present embodiment tends to be excellent in molding processability, be prevented from generating an uneven thickness or an unmelted material in the form of a microporous membrane (homogeneity), suppress residual stress in a microporous membrane (low rate of shrinkage), be miscible with other polyethylene resins, and be unlikely to segregate in a microporous membrane even at the time of blending.

In the present embodiment, the viscosity-average molecular weight of the polyethylene powder can be measured by a method described in Examples mentioned later.

(Temperature Difference (Tm2_{end}−Tm2ₜₒₚ) in DSC Curve)

The temperature difference (Tm2_{end}−Tm2ₜₒₚ) in the DSC curve of the polyethylene powder of the present embodiment is 5° C. or higher and 9° C. or lower, preferably 6° C. or higher and 8.5° C. or lower, more preferably 6.7° C. or higher and 8° C. or lower. When the polyethylene powder of the present embodiment particularly has a peak top temperature (Tm2ₜₒₚ) of 135° C. or higher and 140° C. or lower, the temperature difference (Tm2_{end}−Tm2ₜₒₚ) in the DSC curve is preferably 6.7° C. or higher and 9.0° C. or lower, more preferably 6.7° C. or higher and 8.5° C. or lower, further preferably 6.7° C. or higher and 8° C. or lower. When the temperature difference (Tm2_{end}−Tm2ₜₒₚ) in the DSC curve is equal to or more than the lower limit value, the polyethylene powder of the present embodiment improves heat resistance owing to a high-melting component in the form of a microporous membrane and can improve heat resistance in the form of a microporous membrane by blending with other polyethylene resins. When the temperature difference (Tm2_{end}−Tm2ₜₒₚ) in the DSC curve is equal to or less than the upper limit value, the polyethylene powder of the present embodiment tends to facilitate closing pores of a microporous membrane at the time of abnormal heat generation of a battery in the form of a microporous membrane for a secondary battery separator and tends to be able to be homogeneously drawn at the time of drawing processing.

Examples of the method for obtaining the polyethylene powder having the temperature difference (Tm2_{end}−Tm2ₜₒₚ) in the DSC curve that falls within the above range include, but are not particularly limited to, a method of producing a polymer so as to contain a very small amount of long-chain branching using a catalyst obtained by a special production method mentioned later. Specific examples thereof include a production method of separately controlling a backbone and a side chain and keeping the ratio of the side chain to a very small amount. Examples of the method for separately controlling a backbone and a side chain include, but are not particularly limited to, a method of using a catalyst containing two types of active species ((A) for macromonomer incorporations and (B) for macromonomer syntheses), using different types of co-catalysts between the active species, premixing the co-catalysts with the active species, and performing supporting at two or more stages to form a multilayer structure on support surface. Examples of the method for keeping the ratio of the side chain to a very small amount include, but are not particularly limited to, a method of controlling the ratio ((A) for macromonomer incorporation/(B) for macromonomer synthesis) between the above two types of active species within the range of 1 to 1000, controlling the ratio ((C)/(A)) between a co-catalyst (C) and the active species (A) for macromonomer incorporations within the range of 0.5 to 1.5, and controlling the ratio ((D)/(B)) between a co-catalyst (D) and the active species (B) for macromonomer syntheses within the range of 1 to 60.

In the present embodiment, the temperature difference (Tm2_{end}−Tm2ₜₒₚ) in the DSC curve of the polyethylene powder can be measured by a method described in Examples mentioned later.

### (Average Shrinkage Factor g_{z})

The average shrinkage factor g_{z} of the polyethylene powder of the present embodiment is preferably 0.600 or more and 1 or less, more preferably 0.65 or more and 0.985 or less, further preferably 0.7 or more and 0.97 or less. When the average shrinkage factor g_{z} is equal to or more than the lower limit value, the polyethylene powder of the present embodiment tends to suppress residual stress in a microporous membrane in the form of a microporous membrane (low rate of shrinkage), be prevented from generating entanglement ascribable to branched chains less than a given level, and be promoted for crystallization. When the average shrinkage factor g_{z} is equal to or less than the upper limit value, the polyethylene powder of the present embodiment tends to easily form high-melting crystals, further improve heat resistance in the form of a microporous membrane because of increased strength at the time of melting, further improve stability at the time of film formation, lead to the suppression of an uneven membrane, and be able to further improve the heat resistance and drawability of a microporous membrane by blending with other polyethylene resins.

Examples of the method for obtaining the polyethylene powder having the average shrinkage factor g_{z} that falls within the above range include, but are not particularly limited to, a method of producing a polymer so as to contain a very small amount of long-chain branching using a catalyst obtained by a special production method mentioned later. Specific examples thereof include a production method of separately controlling a backbone and a side chain and keeping the ratio of the side chain to a very small amount. Examples of the method for separately controlling a backbone and a side chain include, but are not particularly limited to, a method of using a catalyst containing two types of active species ((A) for macromonomer incorporations and (B) for macromonomer syntheses), using different types of co-catalysts between the active species, premixing the co-catalysts with the active species, and performing supporting at two or more stages to form a multilayer structure on support surface. Examples of the method for keeping the ratio of the side chain to a very small amount include, but are not particularly limited to, a method of controlling the ratio ((A) for macromonomer incorporation/(B) for macromonomer synthesis) between the above two types of active species within the range of 1 to 1000, controlling the ratio ((C)/(A)) between a co-catalyst (C) and the active species (A) for macromonomer incorporations within the range of 0.5 to 1.5, and controlling the ratio ((D)/(B)) between a co-catalyst (D) and the active species (B) for macromonomer syntheses within the range of 1 to 60.

In the present embodiment, the average shrinkage factor g_{z} of the polyethylene powder can be measured by a method described in Examples mentioned later.

### (Evaluation of Drawability)

The polyethylene powder of the present embodiment is preferably drawable under the following conditions:

### (Drawing Conditions)

a 100 mm×100 mm×1 mm thick gel sheet made of 30% by mass of the polyethylene powder and 70% by mass of liquid paraffin is drawn at a ratio of 7×7 at 115° C.

When the polyethylene powder of the present embodiment is drawable under the conditions described above, the polyethylene powder of the present embodiment tends to suppress an uneven film thickness in the form of a microporous membrane. Also, the polyethylene powder of the present embodiment tends to be able to produce a microporous membrane with high productivity.

Examples of the method for obtaining the polyethylene powder that is drawable under the conditions described above include, but are not particularly limited to, a method of appropriately adjusting catalyst composition or polymerization conditions and thereby keeping the ratio of an ultrahigh-molecular-weight component (molecular weight >10⁷ or larger) to less than a given level. In the present embodiment, the drawability under the conditions can specifically be evaluated by a method described in Examples mentioned later.

(Absorption Coefficient at 400 cm⁻¹ to 450 cm⁻¹)

The absorption coefficient at 400 cm⁻¹ to 450 cm⁻¹ of the polyethylene powder of the present embodiment in terahertz measurement is preferably 1.0 or more and 4.0 or less, more preferably 1.9 or more and 3.5 or less, further preferably 2.1 or more and 3.5 or less.

Although the attribution of an absorption peak of a terahertz wave at 400 cm⁻¹ to 450 cm⁻¹ is not clear, terahertz waves are absorbed as vibrational energy of a polymer chain, and the absorption peak of a terahertz wave at 500 cm⁻¹ to 550 cm⁻¹ corresponds to the vibration of an amorphous moiety of polyethylene. Therefore, the absorption peak at 400 cm⁻¹ to 450 cm⁻¹ presumably corresponds to vibration derived from a long-chain branch structure present in the amorphous moiety.

When the absorption coefficient at 400 cm⁻¹ to 450 cm⁻¹ falls within the above range in terahertz measurement, the polyethylene powder of the present embodiment tends to suppress residual stress in a microporous membrane (low rate of shrinkage). Also, the polyethylene powder of the present embodiment tends to suppress an uneven film thickness in the form of a microporous membrane.

Examples of the method for obtaining the polyethylene powder having the absorption coefficient at 400 cm⁻¹ to 450 cm⁻¹ that falls within the above range in terahertz measurement include, but are not particularly limited to, a method of appropriately adjusting the types of active species and co-catalysts or their combinations and thereby attaining a homogeneous manner in which the macromonomer is incorporated. In the present embodiment, the absorption coefficient at 400 cm⁻¹ to 450 cm⁻¹ can be evaluated by a method described in Examples mentioned later.

### (¹H-NMR Measurement)

In the polyethylene powder of the present embodiment, no peak is preferably present in the following regions in ¹H-NMR measurement:
(1) 4.8 ppm to 5.0 ppm, and
(2) 5.6 ppm to 6.0 ppm.

Both of (1) and (2) are regions where a signal corresponding to a terminal double bond is detected. No peak present in these regions means that no macromonomer remains in the polyethylene powder.

When no peak is present in the regions shown above in ¹H-NMR measurement, the polyethylene powder of the present embodiment can be homogeneously drawn in the form of a microporous membrane and therefore tends to suppress an uneven film thickness and tends to further suppress residual stress in a microporous membrane (low rate of shrinkage) and produce a homogeneous microporous membrane when blended with other polyethylene resins.

Examples of the method for obtaining the polyethylene powder having no peak present in the regions shown above in ¹H-NMR measurement include, but are not particularly limited to, a method of allowing an active species capable of incorporating a macromonomer to be supported on the outermost surface of a catalyst, or appropriately adjusting the starting material composition of a catalyst and the amount of a comonomer such that no terminal double bond remains. In the present embodiment, the ¹H-NMR peak of the polyethylene powder can be measured by a method described in Examples mentioned later.

### (Aluminum Content)

The aluminum content of the polyethylene powder of the present embodiment is preferably 0 ppm or more and 50 ppm or less, more preferably 0 ppm or more and 30 ppm or less, further preferably 0 ppm or more and 15 ppm or less. When the aluminum content falls within the above range, the polyethylene powder of the present embodiment tends to easily form high-melting crystals, also tends to have high quality in the form of a microporous membrane, and can suppress filter clogging in a molding process, leading to improved productivity.

In the present embodiment, the aluminum content in the polyethylene powder can be measured by a method described in Examples mentioned later.

### (Silicon Content)

The silicon content of the polyethylene powder of the present embodiment is preferably 0 ppm or more and 30 ppm or less, more preferably 0 ppm or more and 10 ppm or less, further preferably 0 ppm or more and 2 ppm or less. When the silicon content falls within the above range, the polyethylene powder of the present embodiment tends to easily form high-melting crystals, also tends to have high quality in the form of a microporous membrane, and can suppress filter clogging in a molding process, leading to improved productivity.

In the present embodiment, the silicon content in the polyethylene powder can be measured by a method described in Examples mentioned later.

### (Peak Top Temperature in DSC Curve of Second Heating Process)

In the polyethylene powder of the present embodiment, the peak top temperature (hereinafter, also referred to as “Tm2ₜₒₚ”) in the DSC curve of the second heating process in differential scanning calorimeter (DSC) measurement is preferably 130° C. or higher and 140° C. or lower, more preferably 133° C. or higher and 140° C. or lower, further preferably 135° C. or higher and 140° C. or lower. When the polyethylene powder of the present embodiment particularly has the crystal thickness parameter of 6.7° C. or higher and 9.0° C. or lower, Tm2ₜₒₚ is preferably 135° C. or higher and 140° C. or lower, more preferably 136° C. or higher and 140° C. or lower, further preferably 137° C. or higher and 140° C. or lower. When Tm2ₜₒₚ falls within the above range, the polyethylene powder of the present embodiment can improve heat resistance in the form of a microporous membrane, can suppress residual stress in a microporous membrane because a temperature can be applied thereto in a heat setting step, and further tends to enhance the air permeability of a microporous membrane.

Examples of the method for obtaining the polyethylene powder having Tm2ₜₒₚ that falls within the above range include, but are not particularly limited to, a method of adjusting the starting material composition of a catalyst or the amount of a comonomer.

In the present embodiment, Tm2ₜₒₚ can be measured by a method described in Examples mentioned later.

### (Density)

The density of the polyethylene powder of the present embodiment is preferably 920 kg/m³ or more and 960 kg/m³ or less, more preferably 930 kg/m³ or more and 955 kg/m³ or less, further preferably 935 kg/m³ or more and 950 kg/m³ or less. When the density falls within the above range, the polyethylene powder of the present embodiment tends to be excellent in air permeability and heat resistance in the form of a microporous membrane.

In the present embodiment, the density of the polyethylene powder can be measured by a method described in Examples mentioned later.

### (Method for Producing Catalyst for Olefin Polymerization)

The method for producing a catalyst for olefin polymerization according to the present embodiment comprises:
a first supporting reaction step of reacting a solid particle [A] with a transition metal compound component [B-1] and/or a transition metal compound component [B-2] and an activating agent [C] and/or an organic metal compound component [D]; and
a second supporting reaction step of reacting the particle obtained in the first supporting reaction step with the transition metal compound component [B-1] and/or the transition metal compound component [B-2] and the activating agent [C] and/or the organic metal compound component [D], wherein
the transition metal compound component [B-1] is a compound represented by the following (Formula 3), the transition metal compound component [B-2] is a compound represented by the following (Formula 4), the activating agent [C] is a compound represented by the following (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table, and
the following <Condition 1> and/or <Condition 2> is satisfied:

### <Condition 1>

the first supporting reaction step comprises: a premixing step of reacting the transition metal compound component [B-1] and/or the transition metal compound component [B-2] with the activating agent [C] and/or the organic metal compound component [D]; and the step of reacting the solid particle [A] with the mixture obtained in the premixing step,

### <Condition 2>

in the first supporting reaction step, a molar ratio (([C]+[D])/[B]) of a molar quantity ([C]+[D]) of the activating agent [C] and the organic metal compound component [D] to a molar quantity [B] of the transition metal compound component [B-1] and/or the transition metal compound component [B-2] is 1 or more and 60 or less,

L¹ⱼWₖM¹X¹ₚX²_{q} (Formula 3)

wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3, or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic 6-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2,

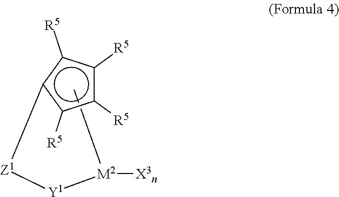

wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,

(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d,

(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.

The transition metal compound for use in the first supporting reaction step is preferably [B-1], and the transition metal compound for use in the second supporting reaction step is preferably [B-2]. In the second supporting reaction step, the molar ratio (([C]+[D])/[B]) of the molar quantity ([C]+[D]) of the activating agent [C] and the organic metal compound component [D] to the molar quantity [B] of the transition metal compound component [B-1] and/or the transition metal compound component [B-2] is preferably 0.5 or more and 1.5 or less, more preferably 0.9 or more and 1.1 or less. The molar ratio ([B₂]/[B₁]) of the transition metal compound component ([B₂]) for use in the second supporting reaction step to the transition metal compound component ([B₁]) for use in the first supporting reaction step is preferably 1 or more and 1000 or less, more preferably 5 or more and 100 or less.

By comprising the first supporting reaction step and the second supporting reaction step, two layers each made of a mixture of the transition metal compound and the activating agent can be formed on the surface of the solid particle [A]. This two-layer structure facilitates controlling long-chain branching in the production of an olefin polymer because a macromonomer formed in the first layer is incorporated into the transition metal compound in the second layer. By controlling the molar ratios (([C]+[D])/[B]) and ([B₂]/[B₁])), the amount of long-chain branching can be kept to a very small amount in the production of an olefin polymer.

The method for producing a catalyst for olefin polymerization according to the present embodiment satisfies the following <Condition 1> and/or <Condition 2>.

### <Condition 1>

The first supporting reaction step comprises: a premixing step of reacting the transition metal compound component [B-1] and/or the transition metal compound component [B-2] with the activating agent [C] and/or the organic metal compound component [D]; and the step of reacting the solid particle [A] with the mixture obtained in the premixing step.

By satisfying <Condition 1>, a layer having the transition metal compound and the activating agent homogeneously mixed with each other tends to be able to be formed on the surface of the solid particle [A]. By forming the homogeneous mixed layer, the manner in which the macromonomer is incorporated becomes homogeneous, and an olefin polymer with less segregation of long-chain branching can be synthesized.

### <Condition 2>

In the first supporting reaction step, a molar ratio (([C]+[D])/[B]) of a molar quantity ([C]+[D]) of the activating agent [C] and the organic metal compound component [D] to a molar quantity [B] of the transition metal compound component [B-1] and/or the transition metal compound component [B-2] is 1 or more and 60 or less, preferably 1 or more and 30 or less.

By satisfying <Condition 2>, the amount of long-chain branching tends to be able to be kept to a very small amount in the production of an olefin polymer because the amount of the macromonomer formed can be reduced.

The method for producing a catalyst for olefin polymerization according to the present embodiment satisfies the step conditions described above and can thereby synthesize an olefin polymer comprising a very small amount of long-chain branching. Furthermore, the amount or length of long-chain branching is easy to control in the production of an olefin polymer.

### (Solid Particle [A] for Use in Method for

Producing Catalyst for Olefin Polymerization) The method for producing a catalyst for olefin polymerization according to the present embodiment preferably employs a magnesium chloride particle as the solid particle [A].

The method for producing a catalyst for olefin polymerization according to the present embodiment employs the magnesium chloride particle as the solid particle [A] and thereby tends to be able to form an olefin polymer having a small content of metal residues because catalyst particles easily crack during polymerization.

### (Catalyst for Olefin Polymerization)

The catalyst for olefin polymerization of the present embodiment comprises a solid particle [A], a transition metal compound component [B-1] and/or a transition metal compound component [B-2], and an activating agent [C] and/or an organic metal compound component [D], wherein
the transition metal compound component [B-1] is a compound represented by the above (Formula 3), the transition metal compound component [B-2] is a compound represented by the above (Formula 4), the activating agent [C] is a compound represented by the above (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table,
a content (mol) of a central metal M contained in the transition metal compound component [B-1] and/or the transition metal compound component [B-2] is 20 μmol or more and 1000 μmol or less, and a molar ratio (Al/M) of a content (mol) of Al to the content (mol) of the central metal M is 1 or more and 30 or less. The content (mol) of the central metal M is preferably 20 μmol or more and 250 μmol or less, and the molar ratio (Al/M) is preferably 1 or more and 10 or less.

The catalyst for olefin polymerization of the present embodiment comprises each of the components described above and has the content (mol) of the central metal M and the molar ratio (Al/M) of the Al content (mol) to the central metal M content (mol) that fall within the above ranges. Thus, the amount or length of long-chain branching is easy to control for an olefin polymer obtained by polymerization, and the amount of long-chain branching in the olefin polymer can also be kept to a very small amount.

In the present embodiment, the content (mol) of the central metal M in the catalytic component and the molar ratio (Al/M) of the content (mol) of Al to the content (mol) of the central metal M can be measured by methods described in Examples mentioned later.

### (Solid Particle [A] Contained in Catalyst for Olefin Polymerization)

In the catalyst for olefin polymerization of the present embodiment, the solid particle [A] is preferably a magnesium chloride particle.

The catalyst for olefin polymerization of the present embodiment comprises the magnesium chloride particle as the solid particle [A] and thereby tends to be able to form an olefin polymer having a small content of metal residues because catalyst particles easily crack during polymerization.

The contents of the solid particle [A], the transition metal compound component [B-1], the transition metal compound component [B-2], the activating agent [C], and the organic metal compound component [D] described in [Method for producing polyethylene powder] mentioned later can be appropriately applied to the solid particle [A], the transition metal compound component [B-1], the transition metal compound component [B-2], the activating agent [C], and the organic metal compound component [D] in the catalyst for olefin polymerization of the present embodiment. Each condition described in [Method for producing polyethylene powder] mentioned later can be appropriately applied to each condition in a method for producing the catalyst for olefin polymerization of the present embodiment.

The method for producing an olefin polymer according to the present embodiment comprises the step of polymerizing olefin using the catalyst for olefin polymerization mentioned above.

### [Method for Producing Polyethylene Powder]

Hereinafter, one example of the method for producing a polyethylene powder according to the present embodiment will be described.

### (Catalytic Component)

The polyethylene powder of the present embodiment can be produced, for example, by polymerizing ethylene or ethylene and another comonomer using a predetermined catalytic component.

The catalytic component for use in the production of an ethylenic polymer constituting the polyethylene powder of the present embodiment is not particularly limited and is preferably constituted by, for example, a solid particle [A], a transition metal compound component [B-1] and/or a transition metal compound component [B-2], and an activating agent [C] and/or an organic metal compound component [D].

In the present embodiment, examples of the solid particle [A] include, but are not particularly limited to, porous polymer materials (provided that matrices include, for example, polyolefin and its modification products such as polyethylene, polypropylene, polystyrene, ethylene-propylene copolymers, ethylene-vinyl ester copolymers, styrene-divinylbenzene copolymers, and partial or complete saponification products of ethylene-vinyl ester copolymers, thermoplastic resins such as polyamide, polycarbonate, and polyester, and thermosetting resins such as phenol resins, epoxy resins, urea resins, and melamine resins), inorganic solid particles containing at least one element selected from the group consisting of group 2 to group 4, group 13, and group 14 of the periodic table (e.g., silica, alumina, magnesia, magnesium chloride, zirconia, titania, boron oxide, calcium oxide, zinc oxide, barium oxide, vanadium pentoxide, chromium oxide, thorium oxide, and mixtures and complex oxides thereof).

Examples of the complex oxide containing silica include, but are not particularly limited to, complex oxide of silica and oxide of an element selected from elements belonging to group 2 or group 13 of the periodic table, such as silica-magnesia and silica-alumina. In the present embodiment, the solid particle [A] is preferably selected from silica, alumina, and complex oxide of silica and oxide of an element selected from elements belonging to group 2 or group 13 of the periodic table.

The form of the silica product for use as the solid particle [A] is not particularly limited, and the form of silica may be any form such as a granular, spherical, aggregated, or fumed form. Preferred examples of a commercially available silica product include, but are not particularly limited to, SD3216.30, SP-9-10046, Davison Syloid™ 245, Davison 948, and Davison 952 [all manufactured by GRACE Davison (a division of W.R. Grace & Co. (USA))], Aerosil 812 [produced by Degussa AG (Germany)], ES70X [manufactured by Crosfield (USA)], P-6, P-10, and Q-6 [manufactured by Fuji Silysia Chemical Ltd. (Japan)].

The properties of magnesium chloride for use as the solid particle [A] are not particularly limited. Preferred examples of the production of magnesium chloride include a method of reacting an organic magnesium compound (A-1) represented by the following (Formula 1) which is soluble in an inert hydrocarbon solvent with a chlorinating agent (A-2) represented by the following (Formula 2):

(A-1):(M¹)_{γ}(Mg)_{δ}(R¹)ₑ(R²)_{f}(OR³)_{g} (Formula 1)
wherein M¹ is a metal atom belonging to any group selected from the group consisting of group 12, group 13, and group 14 of the periodic table; each of R¹, R², and R³ is a hydrocarbon group having 1 or more and 20 or less carbon atoms; and each of γ, δ, e, f, and g is a real number that satisfies the following relationships:
0≤γ, 0<δ, 0≤e, 0≤f, 0≤g, 0<e+f, 0≤g/(γ+δ)≤2, and kγ+2δ=e+f+g (wherein k represents the valence of M¹);

(A-2):HₕSiClᵢR⁴₍₄₋₍ₕ₊ᵢ₎₎ (Formula 2)
wherein R⁴ is a hydrocarbon group having 1 or more and 12 or less carbon atoms; and each of h and i is a real number that satisfies the following relationships: 0<h, 0<i, and 0<h+i≤4.

First, the organic magnesium compound (A-1) will be described.

The organic magnesium compound (A-1) is represented in the form of an organic magnesium complex compound soluble in an inert hydrocarbon solvent, and encompasses all of dihydrocarbyl magnesium compounds and their complexes with other metal compounds.

In the above (Formula 1), the above relational expression kγ+2δ=e+f+g of the symbols γ, δ, e, f, and g represents the stoichiometry of metal atom valence and substituents.

In the above (Formula 1), examples of the hydrocarbon group each independently represented by R¹ and R² include, but are not particularly limited to, alkyl groups, cycloalkyl groups, and aryl groups, and more specifically include, but are not particularly limited to, methyl, ethyl, propyl, butyl, pentyl, hexyl, octyl, decyl, cyclohexyl, and phenyl groups.

Among them, each of R¹ and R² is preferably an alkyl group.

When γ>0, a metal atom belonging to any group consisting of group 12, group 13, and group 14 of the periodic table can be used as the metal atom M¹. More specific examples thereof include, but are not particularly limited to, zinc, boron, and aluminum. Aluminum and zinc are particularly preferred.

The ratio δ/γ of magnesium to the metal atom M¹ is not particularly limited and is preferably 0.1 or more and 30 or less, more preferably 0.5 or more and 10 or less.

In the case of using a predetermined organic magnesium compound wherein γ=0 as (A-1), for example, a compound wherein R¹ is a 1-methylpropyl group is soluble in an inert hydrocarbon solvent. Such a compound also brings about a preferred consequence in the production of the polyethylene powder of the present embodiment.

In the above (Formula 1), when γ=0, the hydrocarbon groups R¹ and R² are preferably any one of the following three groups (1), (2), and (3).

### Group (1):

At least one of R¹ and R² is a secondary or tertiary alkyl group having 4 or more and 6 or less carbon atoms. Preferably, both of R¹ and R² are alkyl groups having 4 or more and 6 or less carbon atoms and at least one of the groups is a secondary or tertiary alkyl group.

### Group (2):

R¹ and R² are alkyl groups differing in the number of carbon atoms from each other. Preferably, R¹ is an alkyl group having 2 or 3 carbon atoms, and R² is an alkyl group having 4 or more carbon atoms; and Group (3):

At least one of R¹ and R² is a hydrocarbon group having 6 or more carbon atoms. An alkyl group in which the total number of carbon atoms contained in R¹ and R² is 12 or more is preferred.

Hereinafter, the hydrocarbon groups R¹ and R² will be specifically described when γ=0 in the above (Formula 1).

In the group (1), examples of the secondary or tertiary alkyl group having 4 or more and 6 or less carbon atoms include, but are not particularly limited to, 1-methylpropyl, 2-methylpropyl, 1,1-dimethylethyl, 2-methylbutyl, 2-ethylpropyl, 2,2-dimethylpropyl, 2-methylpentyl, 2-ethylbutyl, 2,2-dimethylbutyl, and 2-methyl-2-ethylpropyl groups. A 1-methylpropyl group is particularly preferred.

In the group (2), examples of the alkyl group having 2 or 3 carbon atoms include, but are not particularly limited to, ethyl, 1-methylethyl, and propyl groups. An ethyl group is particularly preferred.

Examples of the alkyl group having 4 or more carbon atoms include, but are not particularly limited to, butyl, pentyl, hexyl, heptyl, and octyl groups. Butyl and hexyl groups are particularly preferred.

In the group (3), examples of the hydrocarbon group having 6 or more carbon atoms include, but are not particularly limited to, hexyl, heptyl, octyl, nonyl, decyl, phenyl, and 2-naphthyl groups. Among the hydrocarbon groups, alkyl groups are preferred. Among the alkyl groups, hexyl and octyl groups are more preferred.

According to general tendencies, an alkyl group containing a larger number of carbon atoms is more soluble in an inert hydrocarbon solvent and forms a solution having a higher viscosity. Hence, a moderately long-chain alkyl group is preferably used as each of the hydrocarbon groups R¹ and R² in the above (Formula 1) in terms of handling. The organic magnesium compound (A-1) is used as an inert hydrocarbon solution. This solution can be used without any problem even if very small amounts of Lewis basic compounds such as ether, ester, and amine are contained or remain therein.

Next, the alkoxy group (OR³) in (Formula 1) of the organic magnesium compound (A-1) will be described.

The hydrocarbon group represented by R³ is preferably an alkyl group or an aryl group having 1 or more and 12 or less carbon atoms, more preferably an alkyl group or an aryl group having 3 or more and 10 or less carbon atoms.

Examples of R³ include, but are not particularly limited to, methyl, ethyl, propyl, 1-methylethyl, butyl, 1-methylpropyl, 1,1-dimethylethyl, pentyl, hexyl, 2-methylpentyl, 2-ethylbutyl, 2-ethylpentyl, 2-ethylhexyl, 2-ethyl-4-methylpentyl, 2-propylheptyl, 2-ethyl-5-methyloctyl, octyl, nonyl, decyl, phenyl, and naphthyl groups.

Particularly, butyl, 1-methylpropyl, 2-methylpentyl, and 2-ethylhexyl groups are more preferred.

Examples of a method for synthesizing the organic magnesium compound (A-1) include, but are not particularly limited to, a synthesis method of reacting any organic magnesium compound belonging to the group consisting of the formulas R¹MgX¹ and R¹₂Mg (wherein R¹ is as defined above, and X¹ is a halogen atom) with any organic metal compound belonging to the group consisting of the formulas M¹R²ₖ and M¹R²₍ₖ₋₁₎H (wherein M¹, R², and k are as defined above) at a temperature of 25° C. or higher and 150° C. or lower in an inert hydrocarbon solvent and, if necessary, subsequently with an alcohol having a hydrocarbon group represented by R² (wherein R² is as defined above) or an alkoxy magnesium compound and/or an alkoxy aluminum compound having a hydrocarbon group represented by R² which is soluble in an inert hydrocarbon solvent.

Among the methods mentioned above, in the case of reacting the organic magnesium compound soluble in an inert hydrocarbon solvent with an alcohol, the order of reaction is not particularly limited. Any of the following methods can be used: the alcohol is added into the organic magnesium compound; the organic magnesium compound is added into the alcohol; and both of the compounds are added at the same time.

The reaction ratio between the organic magnesium compound soluble in an inert hydrocarbon solvent and the alcohol is not particularly limited, and the molar composition ratio g/(γ+δ) of the alkoxy group to all metal atoms in the resulting alkoxy group-containing organic magnesium compound is 0≤g/(γ+δ)≤2, preferably 0≤g/(γ+δ)<1.

Next, the chlorinating agent (A-2) will be described.

The chlorinating agent (A-2) is a silicon chloride compound having at least one Si—H bond, represented by (Formula 2):

(A-2):HₕSiClᵢR⁴₍₄₋₍ₕ₊ᵢ₎₎ (Formula 2)
wherein R⁴ is a hydrocarbon group having 1 or more and 12 or less carbon atoms; and each of h and i is a real number that satisfies the following relationships: 0<h, 0<i, and 0<h+i≤4.

In the above (Formula 2), examples of the hydrocarbon group represented by R⁴ include, but are not particularly limited to, aliphatic hydrocarbon groups, alicyclic hydrocarbon groups, and aromatic hydrocarbon groups, and specifically include methyl, ethyl, propyl, 1-methylethyl, butyl, pentyl, hexyl, octyl, decyl, cyclohexyl, and phenyl groups.

Particularly, alkyl groups having 1 or more and 10 or less carbon atoms are preferred, and alkyl groups having 1 or more and 3 or less carbon atoms, such as methyl, ethyl, propyl, and 1-methylethyl groups are more preferred. Each of h and i is a number larger than 0 that satisfies the relationship h+i 4. Preferably, i is 2 or larger and 3 or smaller.

Examples of the chlorinating agent (A-2) include, but are not particularly limited to, HSiCl₃, HSiCl₂CH₃, HSiCl₂C₂H₅, HSiCl₂(C₃H₇), HSiCl₂(2-C₃H₇), HSiCl₂(C₄H₉), HSiCl₂(C₆H₅), HSiCl₂(4-Cl—C₆H₄), HSiCl₂(CH═CH₂), HSiCl₂(CH₂C₆H₅), HSiCl₂(1-C₁₀H₇), HSiCl₂(CH₂CH═CH₂), H₂SiCl(CH₃), H₂SiCl(C₂H₅), HSiCl(CH₃)₂, HSiCl(C₂H₅)₂, HSiCl(CH₃)(2-C₃H₇), HSiCl(CH₃)(C₆H₅), and HSiCl(C₆H₅)₂

These silicon chloride compounds are used each singly or as a mixture of two or more types selected from these compounds as the chlorinating agent (A-2).

Particularly, HSiCl₃, HSiCl₂CH₃, HSiCl(CH₃)₂, and HSiCl₂(C₃H₇) are preferred, and HSiCl₃ and HSiCl₂CH₃ are more preferred.

Next, the reaction between the organic magnesium compound (A-1) and the chlorinating agent (A-2) will be described.

For the reaction, the chlorinating agent (A-2) is preferably used after being diluted in advance with an inert hydrocarbon solvent, chlorinated hydrocarbon (e.g., 1,2-dichloroethane, o-dichlorobenzene, or dichloromethane), an ether solvent (e.g., diethyl ether or tetrahydrofuran), or a mixed solvent thereof. Among them, an inert hydrocarbon solvent is more preferably used in terms of the performance of the catalyst.

The reaction ratio between the organic magnesium compound (A-1) and the chlorinating agent (A-2) is not particularly limited, and the number of moles of a silicon atom contained in the chlorinating agent (A-2) per mol of a magnesium atom contained in the organic magnesium compound (A-1) is preferably 0.01 mol or more and 100 mol or less, further preferably 0.1 mol or more and 10 mol or less.

The method for reacting the organic magnesium compound (A-1) with the chlorinating agent (A-2) is not particularly limited. Any of the following methods can be used: the organic magnesium compound (A-1) and the chlorinating agent (A-2) are reacted while introduced at the same time to a reactor (simultaneous addition method); a reactor is charged with the chlorinating agent (A-2) in advance, and then, the organic magnesium compound (A-1) is introduced to the reactor; and a reactor is charged with the organic magnesium compound (A-1) in advance, and then, the chlorinating agent (A-2) is introduced to the reactor. Particularly, the method of charging a reactor with the chlorinating agent (A-2) in advance and then introducing the organic magnesium compound (A-1) to the reactor is preferred.

The temperature of the reaction between the organic magnesium compound (A-1) and the chlorinating agent (A-2) is not particularly limited and is preferably 25° C. or higher and 150° C. or lower, more preferably 30° C. or higher and 120° C. or lower, further preferably 40° C. or higher and 100° C. or lower.

In the simultaneous addition method in which the organic magnesium compound (A-1) and the chlorinating agent (A-2) are reacted while introduced at the same time to a reactor, the reaction temperature is preferably adjusted by adjusting the temperature of the reactor to a predetermined temperature in advance and adjusting the temperature in the reactor to a predetermined temperature while performing the simultaneous addition.

In the method of charging a reactor with the chlorinating agent (A-2) in advance and then introducing the organic magnesium compound (A-1) to the reactor, the reaction temperature is preferably adjusted by adjusting the temperature of the reactor charged with the chlorinating agent (A-2) to a predetermined temperature and adjusting the temperature in the reactor to a predetermined temperature while introducing the organic magnesium compound (A-1) to the reactor.

In the method of charging a reactor with the organic magnesium compound (A-1) in advance and then introducing the chlorinating agent (A-2) to the reactor, the reaction temperature is preferably adjusted by adjusting the temperature of the reactor charged with the organic magnesium compound (A-1) to a predetermined temperature and adjusting the temperature in the reactor to a predetermined temperature while introducing the chlorinating agent (A-2) to the reactor.

Magnesium chloride obtained through the reaction is preferably separated by filtration or decantation and then thoroughly washed with an inert hydrocarbon solvent to remove unreacted materials or by-products, etc.

Next, the transition metal compound component [B-1] used in the present embodiment will be described.

Examples of the transition metal compound component [B-1] used in the present embodiment can include, but are not particularly limited to, a compound represented by the following (Formula 3):

L¹ⱼWₖM¹X¹ₚX²_{q} (Formula 3)

wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3, or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic 6-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2.

Examples of the ligand X¹ in the compound of the above (Formula 3) include, but are not particularly limited to, hydride, halide, hydrocarbon groups having 1 to 60 carbon atoms, hydrocarbyloxy groups having 1 to 60 carbon atoms, hydrocarbylamide groups having 1 to 60 carbon atoms, hydrocarbyl phosphite groups having 1 to 60 carbon atoms, hydrocarbyl sulfide having 1 to 60 carbon atoms, a silyl group, and complex groups thereof.

Examples of the neutral Lewis base-coordinating compound X² in the compound of the above (Formula 3) include, but are not particularly limited to, phosphine, ether, amine, olefin having 2 to 40 carbon atoms, diene having 3 to 40 carbon atoms, and divalent groups derived from these compounds.

The structure of the transition metal compound component [B-1] used in the present embodiment is not particularly limited, and a compound that permits polymerization for ultrahigh-molecular-weight polyethylene is preferably used from the viewpoint of reducing the branched chain mobility of polyethylene.

Specific examples of the transition metal compound component [B-1] used in the present embodiment include, but are not particularly limited to, the following compounds:
bis(methylcyclopentadienyl)zirconium dimethyl,
bis(n-butylcyclopentadienyl)zirconium dimethyl,
bis(indenyl)zirconium dimethyl,
bis(1,3-dimethylcyclopentadienyl)zirconium dimethyl,
(pentamethylcyclopentadienyl) (cyclopentadienyl)zirconium dimethyl,
bis(cyclopentadienyl)zirconium dimethyl,
bis(pentamethylcyclopentadienyl)zirconium dimethyl,
bis(fluorenyl)zirconium dimethyl,
bis(methylcyclopentadienyl)titanium dimethyl,
bis(n-butylcyclopentadienyl)titanium dimethyl,
bis(indenyl)titanium dimethyl,
bis(1,3-dimethylcyclopentadienyl)titanium dimethyl,
(pentamethylcyclopentadienyl) (cyclopentadienyl)titanium dimethyl,
bis(cyclopentadienyl)titanium dimethyl,
bis(pentamethylcyclopentadienyl)titanium dimethyl,
bis(fluorenyl)titanium dimethyl,
ethylenebis(indenyl)zirconium dimethyl,
ethylenebis(4,5,6,7-tetrahydro-1-indenyl)zirconium dimethyl,
ethylenebis(4-methyl-1-indenyl)zirconium dimethyl,
ethylenebis(5-methyl-1-indenyl)zirconium dimethyl,
ethylenebis(6-methyl-1-indenyl)zirconium dimethyl,
ethylenebis(7-methyl-1-indenyl)zirconium dimethyl,
ethylenebis(5-methoxy-1-indenyl)zirconium dimethyl,
ethylenebis(2,3-dimethyl-1-indenyl)zirconium dimethyl,
ethylenebis(4,7-dimethyl-1-indenyl)zirconium dimethyl,
ethylenebis-(4,7-dimethoxy-1-indenyl)zirconium dimethyl,
methylenebis(cyclopentadienyl)zirconium dimethyl,
isopropylidenebis(cyclopentadienyl)zirconium dimethyl,
isopropylidene(cyclopentadienyl-fluorenyl)zirconium dimethyl,
silylenebis(cyclopentadienyl)zirconium dimethyl,
dimethylsilylenebis(cyclopentadienyl)zirconium dimethyl,
[(N-t-butylamido) (tetramethyl-η5-cyclopentadienyl)-1,2-ethanediyl]titanium dimethyl,
[(N-t-butylamido) (tetramethyl-η5-cyclopentadienyl)dimethylsilane]titanium dimethyl,
[(N-methylamido) (tetramethyl-η5-cyclopentadienyl)dimethylsilane]titanium dimethyl,
[(N-phenylamido) (tetramethyl-η5-cyclopentadienyl)dimethylsilane]titanium dimethyl,
[(N-benzylamido) (tetramethyl-η5-cyclopentadienyl)dimethylsilane]titanium dimethyl,
[(N-t-butylamido) (η5-cyclopentadienyl)-1,2-ethanediyl]titanium dimethyl,
[(N-t-butylamido) (η5-cyclopentadienyl)dimethylsilane]titanium dimethyl,
[(N-methylamido) (η5-cyclopentadienyl)-1,2-ethanediyl]titanium dimethyl,
[(N-methylamido) (η5-cyclopentadienyl)dimethylsilane]titanium dimethyl,
[(N-t-butylamido) (η5-indenyl)dimethylsilane]titanium dimethyl,
[(N-benzylamido) (η5-indenyl)dimethylsilane]titanium dimethyl,
dibromobistriphenylphosphine nickel,
dichlorobistriphenylphosphine nickel,
dibromodiacetonitrile nickel,
dibromodibenzonitrile nickel,
dibromo(1,2-bisdiphenylphosphinoethane)nickel,
dibromo(1,31-bisdiphenylphosphinopropane)nickel,
dibromo(1,1-bisdiphenylphosphinoferrocene)nickel,
dimethylbisdiphenylphosphine nickel,
dimethyl(1,2-bisdiphenylphosphinoethane)nickel,
methyl (1,2-bisdiphenylphosphinoethane) nickel tetrafluoroborate,
(2-diphenylphosphino-1-phenylethyleneoxy)phenylpyridine nickel,
dichlorobistriphenylphosphine palladium,
dichlorodibenzonitrile palladium, dichlorodiacetonitrile palladium,
dichloro(1,2-bisdiphenylphosphinoethane) palladium,
bistriphenylphosphine palladium bistetrafluoroborate, and
bis(2,2′-bipyridine)methyl iron tetrafluoroborate etherate.

Specific examples of the transition metal compound component [B-1] used in the present embodiment further include, but are not particularly limited to, compounds named by the replacement of the moiety “dimethyl” (which appears at the end of the name of each compound, i.e., immediately after the moiety “zirconium” or “titanium”, and corresponds to the moiety of X¹ or X² in the above (Formula 3)) in the name of each zirconium compound or titanium compound listed above with, for example, any of
“dichloro”,
“dibromo”,
“diiodo”,
“diethyl”,
“dibutyl”,
“diphenyl”,
“dibenzyl”,
“2-(N,N-dimethylamino)benzyl”,
“2-butene-1,4-diyl”,
“s-trans-η4-1,4-diphenyl-1,3-butadiene”,
“s-trans-η4-3-methyl-1,3-pentadiene”,
“s-trans-η4-1,4-dibenzyl-1,3-butadiene”,
“s-trans-η4-2,4-hexadiene”,
“s-trans-η4-1,3-pentadiene”,
“s-trans-η4-1,4-ditolyl-1,3-butadiene”,
“s-trans-η4-1,4-bis(trimethylsilyl)-1,3-butadiene”,
“s-cis-η4-1,4-diphenyl-1,3-butadiene”,
“s-cis-η4-3-methyl-1,3-pentadiene”,
“s-cis-η4-1,4-dibenzyl-1,3-butadiene”,
“s-cis-η4-2,4-hexadiene”,
“s-cis-η4-1,3-pentadiene”,
“s-cis-η4-1,4-ditolyl-1,3-butadiene”, and
“s-cis-η4-1,4-bis(trimethylsilyl)-1,3-butadiene”.

As a specific example, such a transition metal compound component [B-1] is preferably bis(pentamethylcyclopentadienyl)titanium dichloride.

The transition metal compound component [B-1] used in the present embodiment is not particularly limited and can be synthesized by a method generally known in the art.

Next, the transition metal compound component [B-2] used in the present embodiment will be described.

The transition metal compound component [B-2] is not particularly limited and is preferably a compound represented by the following (Formula 4) from the viewpoint of macromonomer incorporation efficiency:

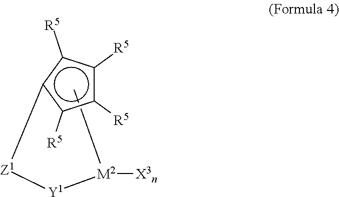

wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,

Specific examples of the transition metal compound component [B-2] used in the present embodiment include, but are not particularly limited to, the following compounds:
[(N-t-butylamido) (tetramethyl-η5-cyclopentadienyl)-1,2-ethanediyl]titanium dimethyl,
[(N-t-butylamido) (tetramethyl-η5-cyclopentadienyl)dimethylsilane]titanium dimethyl,
[(N-methylamido) (tetramethyl-η5-cyclopentadienyl)dimethylsilane]titanium dimethyl,
[(N-phenylamido) (tetramethyl-η5-cyclopentadienyl)dimethylsilane]titanium dimethyl,
[(N-benzylamido) (tetramethyl-η5-cyclopentadienyl)dimethylsilane]titanium dimethyl,
[(N-t-butylamido) (η5-cyclopentadienyl)-1,2-ethanediyl]titanium dimethyl,
[(N-t-butylamido) (η5-cyclopentadienyl)dimethylsilane]titanium dimethyl,
[(N-methylamido) (η5-cyclopentadienyl)-1,2-ethanediyl]titanium dimethyl,
[(N-methylamido) (η5-cyclopentadienyl)dimethylsilane]titanium dimethyl,
[(N-t-butylamido) (η5-indenyl)dimethylsilane]titanium dimethyl, and
[(N-benzylamido) (η5-indenyl)dimethylsilane]titanium dimethyl.

Specific examples of the transition metal compound component [B-2] used in the present embodiment further include, but are not particularly limited to, compounds named by the replacement of the moiety “dimethyl” (which appears at the end of the name of each compound, i.e., immediately after the moiety “titanium”, and corresponds to the moiety of X³ in the above (Formula 4)) in the name of each titanium compound listed above with, for example, any of “dichloro”,
“dibromo”,
“diiodo”,
“diethyl”,
“dibutyl”,
“diphenyl”,
“dibenzyl”,
“2-(N,N-dimethylamino)benzyl”,
“2-butene-1,4-diyl”,
“s-trans-η4-1,4-diphenyl-1,3-butadiene”,
“s-trans-η4-3-methyl-1,3-pentadiene”,
“s-trans-η4-1,4-dibenzyl-1,3-butadiene”,
“s-trans-η4-2,4-hexadiene”,
“s-trans-η4-1,3-pentadiene”,
“s-trans-η4-1,4-ditolyl-1,3-butadiene”,
“s-trans-η4-1,4-bis(trimethylsilyl)-1,3-butadiene”,
“s-cis-η4-1,4-diphenyl-1,3-butadiene”,
“s-cis-η4-3-methyl-1,3-pentadiene”,
“s-cis-η4-1,4-dibenzyl-1,3-butadiene”,
“s-cis-η4-2,4-hexadiene”,
“s-cis-η4-1,3-pentadiene”,
“s-cis-η4-1,4-ditolyl-1,3-butadiene”, and
“s-cis-η4-1,4-bis(trimethylsilyl)-1,3-butadiene”.

As a specific example, such a transition metal compound component [B-2] is preferably a [(N-t-butylamido) (tetramethyl-η5-cyclopentadienyl)dimethylsilane]titanium complex.

The transition metal compound component [B-2] used in the present embodiment is not particularly limited and can be synthesized by a method generally known in the art.

Next, the activating agent [C] and the organic metal compound component [D] capable of forming a complex that exerts catalytic activity by reacting with the transition metal compound used in the present embodiment will be described.

Examples of the activating agent [C] according to the present embodiment include, but are not particularly limited to, a compound (C-1) defined by the following (Formula 5):

(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d.

Examples of the non-coordinating anion include, but are not particularly limited to, the following compounds:
tetrakisphenyl borate,
tri(p-tolyl) (phenyl) borate,
tris(pentafluorophenyl) (phenyl) borate,
tris(2,4-dimethylphenyl) (hydroxyphenyl) borate,
tris(3,5-dimethylphenyl) (phenyl) borate,
tris(3,5-di-trifluoromethylphenyl) (phenyl) borate,
tris(pentafluorophenyl) (cyclohexyl) borate,
tris(pentafluorophenyl) (naphthyl) borate,
tetrakis(pentafluorophenyl) borate,
triphenyl(hydroxyphenyl) borate,
diphenyl-di(hydroxyphenyl) borate,
triphenyl(2,4-dihydroxyphenyl) borate,
tri(p-tolyl) (hydroxyphenyl) borate,
tris(pentafluorophenyl) (hydroxyphenyl) borate,
tris(2,4-dimethylphenyl) (hydroxyphenyl) borate,
tris(3,5-dimethylphenyl) (hydroxyphenyl) borate,
tris(3,5-di-trifluoromethylphenyl) (hydroxyphenyl) borate,
tris(pentafluorophenyl) (2-hydroxyethyl) borate,
tris(pentafluorophenyl) (4-hydroxybutyl) borate,
tris(pentafluorophenyl) (4-hydroxy-cyclohexyl) borate,
tris(pentafluorophenyl) (4-(4′-hydroxyphenyl)phenyl) borate,
tris(pentafluorophenyl) (6-hydroxy-2-naphthyl) borate, and
tris(pentafluorophenyl) (4-hydroxyphenyl) borate.

Other preferred examples of the non-coordinating anion include, but are not particularly limited to, borates derived from the borates listed above by the replacement of the hydroxy group with a NHR group wherein R is preferably a methyl group, an ethyl group, or a tert-butyl group.

Examples of the proton-donating Bronsted acid include, but are not particularly limited to trialkyl group-substituted ammonium cations such as triethylammonium, tripropylammonium, tri(n-butyl)ammonium, trimethylammonium, tributylammonium, and tri(n-octyl)ammonium, and also preferably include N,N-dialkylanilinium cations such as N,N-dimethylanilinium, N,N-diethylanilinium, N,N-2,4,6-pentamethylanilinium, and N,N-dimethylbenzylanilinium. Further examples thereof preferably include dialkylammonium cations such as di-(i-propyl)ammonium and dicyclohexylammonium, and also preferably include: triarylphosphonium cations such as triphenylphosphonium, tri(methylphenyl)phosphonium, and tri(dimethylphenyl)phosphonium; and dimethylsulfonium, diethylsulfonium, and diphenylsulfonium.

The activating agent (C-1) used in the present embodiment may be a reaction product with an organic aluminum compound. Examples of the organic aluminum compound include, but are not particularly limited to, trimethylaluminum, triethylaluminum, tributylaluminum, trihexylaluminum, trioctylaluminum, tridecylaluminum, and reaction products of such alkylaluminum with alcohols such as methyl alcohol, ethyl alcohol, butyl alcohol, pentyl alcohol, hexyl alcohol, octyl alcohol, and decyl alcohol, for example, dimethylmethoxyaluminum, diethylethoxyaluminum, and dibutylbutoxyaluminum. These reaction products with the organic aluminum compound may be used each singly or may be used as a mixture.

In the present embodiment, an organic metal oxy compound (C-2) having a unit represented by the following (Formula 6) can also be used as the activating agent [C]:

(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.

Examples of the activating agent (C-2) include, but are not particularly limited to, an organic aluminum oxy compound represented by the following (Formula 7):

[—Al(Me)-O—]ᵥ—[—Al(R¹)—O-]_{w} (Formula 7)

In the formula, R⁸ is a hydrocarbon group having 1 to 12 carbon atoms. In the above formula, specific examples of R⁸ include, but are not particularly limited to, a methyl group, an ethyl group, a n-propyl group, an isopropyl group, a n-butyl group, an isobutyl group, a pentyl group, a hexyl group, an octyl group, a decyl group, a cyclohexyl group, and a cyclooctyl group. Among them, a methyl group and an ethyl group are preferred, and a methyl group is particularly preferred. In the above formula, examples of the organic aluminum oxy compound constituted by one type of alkylaluminum unit include, but are not particularly limited to, methylalumoxane, ethylalumoxane, n-propylalumoxane, isopropylalumoxane, n-butylalumoxane, isobutylalumoxane, pentylalumoxane, hexylalumoxane, octylalumoxane, decylalumoxane, cyclohexylalumoxane, and cyclooctylalumoxane. Among them, methylalumoxane and ethylalumoxane are preferred, and methylalumoxane is particularly preferred.

As mentioned above, the organic aluminum oxy compound used in the present embodiment is constituted by an alkyloxyaluminum unit represented by the above formula. This compound is not necessarily limited to a compound composed of one type of constituent unit and may be composed of plural types of constituent units. Specific examples thereof include, but are not particularly limited to, methylethylalumoxane, methylpropylalumoxane, and methylbutylalumoxane. The ratio of each constituent unit can be arbitrarily adopted within the range of 0 to 100%. Alternatively, a mixture of plural types of organic aluminum oxy compounds each composed of one type of constituent unit may be used. Specific examples thereof include, but are not particularly limited to, a mixture of methylalumoxane and ethylalumoxane, a mixture of methylalumoxane and n-propylalumoxane, and a mixture of methylalumoxane and isobutylalumoxane. v and w can each take an arbitrary number, and the ratio of v to w, v/w, is preferably 0.1 or more and 10 or less, further preferably 0.3 or more and 5 or less, from the viewpoint of easy production.

The organic aluminum oxy compound used in the present embodiment may contain an unreacted chemical substance resulting from its production method. Specifically, the organic aluminum oxy compound is generally obtained through the reaction of trialkylaluminum with H₂O. A portion of these starting materials may remain as an unreacted chemical substance. In the case of methylalumoxane which is synthesized using trimethylaluminum and H₂O as starting materials, specific examples of such an unreacted chemical substance include, but are not particularly limited to, one or both of these starting materials contained in methylalumoxane. In the method for producing the organic aluminum oxy compound as illustrated above, trialkylaluminum is often contained as a residual chemical substance in the organic aluminum oxy compound because trialkylaluminum is usually used in a larger amount than that of H₂O.

The organic metal compound component [D] according to the present embodiment is preferably a compound containing at least one metal selected from the group consisting of group 1, group 2, group 12, and group 13 of the periodic table, particularly preferably an organic aluminum compound and/or an organic magnesium compound.

Compounds represented by the following (Formula 8) are preferably used each singly or as a mixture as the organic aluminum compound:

(D-1):AlR⁸ₗZ²₍₃₋ₗ₎ (Formula 8)
wherein R⁸ represents a hydrocarbon group having 1 or more and 20 or less carbon atoms, Z² represents any group selected from the group consisting of hydrogen, halogen, alkoxy, allyloxy, and siloxy groups, and 1 represents any number of 2 or larger and 3 or smaller.

In the above (Formula 8), examples of the hydrocarbon group having 1 or more and 20 or less carbon atoms, represented by R⁸ include, but are not particularly limited to, aliphatic hydrocarbon groups, aromatic hydrocarbon groups, and alicyclic hydrocarbon groups. Preferred examples thereof specifically include: trialkylaluminum such as trimethylaluminum, triethylaluminum, tripropylaluminum, tributylaluminum, tri(2-methylpropyl)aluminum (or triisobutylaluminum), tripentylaluminum, tri(3-methylbutyl)aluminum, trihexylaluminum, trioctylaluminum, and tridecylaluminum; aluminum halide compounds such as diethylaluminum chloride, ethylaluminum dichloride, bis(2-methylpropyl)aluminum chloride, ethylaluminum sesquichloride, and diethylaluminum bromide; alkoxyaluminum compounds such as diethylaluminum ethoxide and bis(2-methylpropyl)aluminum butoxide; siloxyaluminum compounds such as dimethylhydrosiloxyaluminum dimethyl, ethylmethylhydrosiloxyaluminum diethyl, and ethyldimethylsiloxyaluminum diethyl; and mixtures thereof. Particularly, trialkylaluminum compounds are more preferred.

Organic magnesium compounds (A-1) represented by the above (Formula 1) are preferably used each singly or as a mixture as the organic magnesium compound.

γ, δ, e, f, g, M¹, R¹, R², and OR³ in the above (Formula 1) are as already mentioned. β/α is preferably in the range of 0.5 to 10, and a compound wherein M¹ is aluminum is further preferred, because higher solubility of this organic magnesium compound in an inert hydrocarbon solvent is more preferred.

Organic magnesium compounds (D-2) represented by the following (Formula 9) may be used each singly or as a mixture as other organic magnesium compounds:

(D-2):(M⁵)_{α}(Mg)_{β}(R⁹)ₐ(R¹⁰)_{b}Y²_{c} (Formula 9)
wherein M⁵ represents a metal atom selected from the group consisting of group 12, group 13, and group 14 of the periodic table, R⁹ and R¹⁰ each represent a hydrocarbon group having 2 or more and 20 or less carbon atoms, Y² represents any of alkoxy, siloxy, allyloxy, amino, amide, —N═C—R¹¹, R¹², —SR¹³ (wherein R¹¹, R¹², and R¹³ each represent a hydrocarbon group having 1 or more and 20 or less carbon atoms, and when c is 2, Y² moieties may be different from each other), and a β-keto acid residue; and α, β, a, b, and c each represent a real number that satisfies the following relationships: 0≤α, 0<β, 0≤a, 0≤b, 0≤c, 0<a+b, 0≤c/(α+β)≤2, and mα+2β=a+b+c (wherein m represents the valence of M⁵).

Next, one example of the method for producing a polymerization catalyst for polyethylene from the solid particle [A], the transition metal compound component [B-1] and/or the transition metal compound component [B-2], and the activating agent [C], and/or the organic metal compound component [D] will be described.

In the present embodiment, the polymerization catalyst for polyethylene is produced, for example, but not particularly limited to, by reacting the solid particle [A] with the transition metal compound component [B-1] and/or the transition metal compound component [B-2], and the activating agent [C] and/or the organic metal compound component [D].

The reaction is preferably performed in an inert hydrocarbon solvent. Specific examples of the inert hydrocarbon solvent include, but are not particularly limited to, aliphatic hydrocarbons such as pentane, hexane, and heptane, aromatic hydrocarbons such as benzene and toluene, and alicyclic hydrocarbons such as cyclohexane and methylcyclohexane. Among them, an aliphatic hydrocarbon solvent such as hexane or heptane is further preferred for performing the reaction therein.

For the reaction, the transition metal compound component [B-1] and the transition metal compound component [B-2] are preferably dissolved in an inert hydrocarbon solvent and then used in the reaction from the viewpoint of reaction efficiency. Their concentrations for dissolution are not particularly limited and are preferably 0.01 mol/L or higher and 5 mol/L or lower, more preferably 0.05 mol/L or higher and 2 mol/L or lower, from the viewpoint of avoiding segregation on the surface of the solid particle [A].

For the reaction, any one of the transition metal compound component [B-1] and the transition metal compound component [B-2] may be used, and both are preferably used from the viewpoint of controlling the amount of long-chain branching of polyethylene.

For the reaction, the types or amounts of the activating agent [C] and the organic metal compound component [D] are preferably changed on a transition metal compound component basis from the viewpoint of facilitating controlling the amount of long-chain branching of polyethylene. The concentrations of the activating agent [C] and the organic metal compound component [D] are not particularly limited and are preferably 0.01 mol/L or higher and 5 mol/L or lower, more preferably 0.05 mol/L or higher and 2 mol/L or lower, from the viewpoint of reactivity with the transition metal compound component(s). An inert hydrocarbon solvent is preferably used for diluting the activating agent [C] and the organic metal compound component [D].

For the reaction, the method for adding the transition metal compound component [B-1], the transition metal compound component [B-2], the activating agent [C], and the organic metal compound component [D] is not particularly limited and is preferably a method of adding a mixture of the transition metal compound component(s) and the activating agent and/or the organic metal compound component premixed with each other to the solid particle [A] or a method of adding the transition metal compound component(s) and the activating agent and/or the organic metal compound component at the same time to the solid particle [A], from the viewpoint of forming a layer of the transition metal compound component(s) and the activating agent and/or the organic metal compound component. It is also preferred to add the transition metal compound component [B-1] activated with the activating agent [C] and/or the organic metal compound component [D] to the solid particle [A] and then add thereto the transition metal compound component [B-2] activated with the activating agent [C] and/or the organic metal compound component [D], from the viewpoint that a macromonomer formed from the transition metal compound component [B-1] is incorporated in the transition metal compound component [B-2].

The reaction temperature of the reaction is not particularly limited and is preferably −20° C. or higher and 100° C. or lower, more preferably 0° C. or higher and 80° C. or lower, from the viewpoint of reaction efficiency.

For the reaction, the molar ratio ([B-2]/[B-1]) of the transition metal compound component [B-2] to the transition metal compound component [B-1] is not particularly limited and is preferably 1 or more and 1000 or less, more preferably 5 or more and 100 or less, from the viewpoint of controlling the amount of long-chain branching of polyethylene to a very small amount.

For the reaction, the molar ratio ([C]/[B-1]) of the activating agent [C] to the transition metal compound component [B-1] is not particularly limited and, when the activating agent [C] is (C-1), is preferably 0.1 or more and 1 or less, more preferably 0.1 or more and 0.5 or less, from the viewpoint of controlling the amount of long-chain branching of polyethylene to a very small amount.

For the reaction, the molar ratio ([C]/[B-1]) of the activating agent [C] to the transition metal compound component [B-1] is not particularly limited and, when the activating agent [C] is (C-2), is preferably 1 or more and 60 or less, more preferably 1 or more and 30 or less, from the viewpoint of controlling the amount of long-chain branching of polyethylene to a very small amount and reducing the amount of metal residues in polyethylene.

For the reaction, the molar ratio ([D]/[B-1]) of the organic metal compound component [D] to the transition metal compound component [B-1] is not particularly limited and is preferably 1 or more and 60 or less, more preferably 1 or more and 30 or less, from the viewpoint of controlling the amount of long-chain branching of polyethylene to a very small amount and reducing the amount of metal residues in polyethylene.

For the reaction, the molar ratio ([C]/[B-2]) of the activating agent [C] to the transition metal compound component [B-2] is not particularly limited and, when the activating agent [C] is (C-1), is preferably 0.5 or more and 1.5 or less, more preferably 0.9 or more and 1.1 or less, from the viewpoint of controlling the amount of long-chain branching of polyethylene to a very small amount.

For the reaction, the molar ratio ([C]/[B-2]) of the activating agent [C] to the transition metal compound component [B-2] is not particularly limited and, when the activating agent [C] is (C-2), is preferably 2 or more and 200 or less, more preferably 5 or more and 100 or less, from the viewpoint of controlling the amount of long-chain branching of polyethylene to a very small amount and reducing the amount of metal residues in polyethylene.

For the reaction, the molar ratio ([D]/[B-2]) of the organic metal compound component [D] to the transition metal compound component [B-2] is not particularly limited and is preferably 1 or more and 60 or less, more preferably 1 or more and 30 or less, from the viewpoint of controlling the amount of long-chain branching of polyethylene to a very small amount and reducing the amount of metal residues in polyethylene.

Next, a scavenger for impurities for use in polymerization for the polyethylene powder of the present embodiment will be described.

The scavenger for impurities for use in polymerization for the polyethylene powder of the present embodiment is not particularly limited, and the organic metal compound component [D] is preferably used.

The method for adding the organic metal compound component [D] into the polymerization system under polymerization conditions is not particularly limited, and the organic metal compound component [D] may be added separately from the catalytic component into the polymerization system or may be reacted with the catalytic component in advance and then added into the polymerization system.

The concentration of the organic metal compound component [D] in the polymerization system is not particularly limited and is preferably 0.001 mmol/L or higher and 10 mmol/L or lower, more preferably 0.01 mmol/L or higher and 5 mmol/L or lower, still more preferably 0.05 mmol/L or higher and 2 mmol/L or lower, from the viewpoint of completely scavenging impurities or from the viewpoint of the amount of metal residues in the polymer.

In the present embodiment, each organic metal compound component [D] may be used singly, or two or more types of organic metal compound components [D] may be used.

### (Polymerization Method for Ethylenic Polymer)

Examples of the polymerization method for the ethylenic polymer constituting the polyethylene powder of the present embodiment include, but are not particularly limited to, a method of polymerizing ethylene or copolymerizing ethylene and a comonomer by a suspension polymerization method or a gas-phase polymerization method. Among them, a suspension polymerization method which can efficiently remove heat of polymerization is preferred.

In the suspension polymerization method, an inert hydrocarbon vehicle can be used as a solvent, and further, the olefin itself may be used as a solvent.

Examples of the inert hydrocarbon vehicle include, but are not particularly limited to: aliphatic hydrocarbons such as propane, butane, isobutane, pentane, isopentane, hexane, heptane, octane, decane, dodecane, and kerosene; alicyclic hydrocarbons such as cyclopentane, cyclohexane, and methylcyclopentane; aromatic hydrocarbons such as benzene, toluene, and xylene; halogenated hydrocarbons such as ethyl chloride, chlorobenzene, and dichloromethane; and mixtures thereof.

In the present embodiment, the polymerization temperature in the polymerization of ethylene is usually preferably 30° C. or higher and 100° C. or lower, further preferably 35° C. or higher and 95° C. or lower, particularly preferably 40° C. or higher and 90° C. or lower. The polymerization temperature of 30° C. or higher allows for industrially efficient production. On the other hand, the polymerization temperature of 100° C. or lower can suppress clumped scales formed by partial melting of the polymer and allows for continuous and stable production without clogging piping.

The polymerization pressure for the ethylenic polymer in the method for producing the polyethylene powder of the present embodiment is preferably ordinary pressure or higher and 2 MPaG or lower, more preferably 0.2 MPaG or higher and 1.5 MPaG or lower, still more preferably 0.3 MPaG or higher and 0.9 MPaG or lower.

The polymerization pressure of ordinary pressure or higher allows for industrially efficient production. On the other hand, the polymerization pressure of 2 MPaG or lower tends to allow for stable production without forming clumped scales due to rapid polymerization in a polymerization reactor.

For general polymerization for the ethylenic polymer, an antistatic agent such as Stadis or STATSAFE manufactured by Innospec Inc. (agent: Maruwa Bussan K.K.) may be used for suppressing the electrostatic adherence of the polymer to a polymerization reactor.

The antistatic agent such as Stadis or STATSAFE can be diluted with an inert hydrocarbon vehicle and then added to a polymerization reactor through a pump or the like. The addition of the antistatic agent can be performed by a method of adding the antistatic agent to a solid catalyst beforehand or a method of adding the antistatic agent to a polymerization reactor. The amount of the antistatic agent added is preferably 1 ppm or more and 500 ppm or less, more preferably 10 ppm or more and 100 ppm or less, based on the amount of the ethylenic polymer produced per unit time.

The molecular weight of the ethylenic polymer can be controlled by the presence of hydrogen in the polymerization system or by the change of the polymerization temperature, for example, as described in the specification of West German Patent Application Publication No. 3127133. The addition of hydrogen as a chain transfer agent into the polymerization system enables the molecular weight of the ethylenic polymer to be controlled within a proper range. In the case of adding hydrogen into the polymerization system, the mole fraction of hydrogen is preferably 0 mol % or more and 50 mol % or less, more preferably 0 mol % or more and 30 mol % or less, further preferably 0 mol % or more and 20 mol % or less.

In the case of adding hydrogen into the polymerization system, hydrogen may be contacted in advance with a catalyst and then added into the polymerization system from a catalyst introduction line. Immediately after introduction of the catalyst into the polymerization system, rapid polymerization progresses, highly probably resulting in a local high-temperature state, because a catalyst concentration around the introduction line outlet is elevated. On the other hand, hydrogen is contacted with the catalyst before introduction into the polymerization system and is thereby capable of suppressing the initial activity of the catalyst so that the formation of clumped scales ascribable to rapid polymerization or the inactivation of the catalyst at a high temperature, for example, can be suppressed.

In the present embodiment, in addition to each component as mentioned above, other components known in the art to be useful in production of the polyethylene can be included.

The polymerization reaction may be performed by any of batch, semicontinuous, and continuous methods. A continuous method is preferred.

A partial high-temperature state ascribable to rapid ethylene reaction can be suppressed by continuously supplying ethylene gas, a solvent, a catalyst, and the like into the polymerization system while continuously discharging them together with produced polyethylene. Thus, the polymerization system is more stabilized.

Ethylene reaction in a homogeneous state in the polymerization system prevents a branch, a double bond, or the like from being formed in polymer chains or prevents a low-molecular-weight component or an ultrahigh-molecular-weight form from being formed through the degradation or cross-linking of the ethylene polymer. Thus, a crystalline component of the ethylenic polymer is easily formed. This facilitates obtaining a sufficient amount of a crystalline component necessary for achieving strength required for a microporous membrane or the like.

The polymerization reaction for the ethylenic polymer may be performed by a single-stage polymerization method using one polymerization reactor or may be performed by a multistage polymerization method of performing continuous polymerization in order in two or more reactors connected in series.

A suspension containing the ethylenic polymer constituting the polyethylene powder of the present embodiment is quantitatively discharged from the polymerization reactor, transferred to a flash tank, and separated from unreacted ethylene, hydrogen, and the comonomer (only when copolymerization is performed in the reactor).

Any of decantation, centrifugation, and filter filtration methods, for example, can be applied to a method for separating the solvent in the polymerization step for the polyethylene powder of the present embodiment. A centrifugation method which offers good separation efficiency between the ethylenic polymer and the solvent is more preferred.

The method for inactivating the catalyst used in the polymerization step for the ethylenic polymer constituting the polyethylene powder of the present embodiment is not particularly limited, and the inactivation of the catalyst is preferably carried out after separation between the ethylenic polymer and the solvent.

The deposition of a low-molecular-weight component, a catalytic component, or the like contained in the solvent into the ethylenic polymer can be suppressed by introducing an agent for inactivating the catalyst after separation between the polyethylene powder and the solvent.

Examples of the agent for inactivating the catalyst include, but are not particularly limited to, oxygen, water, alcohols, glycols, phenols, carbon monoxide, carbon dioxide, ethers, carbonyl compounds, and alkynes.

In the method for producing the polyethylene powder of the present embodiment, a drying step is preferably carried out after separation of the ethylenic polymer from the solvent. In the drying step, a fluidized-bed dryer such as a rotary kiln system or a paddle system is preferably used. The drying temperature is preferably 50° C. or higher and 150° C. or lower, more preferably 70° C. or higher and 110° C. or lower.

The promotion of drying by introducing an inert gas such as nitrogen to the dryer is also effective. In this respect, a method of entraining steam or the like as the agent for inactivating the catalyst is further effective.

The ethylenic polymer constituting the polyethylene powder of the present embodiment may be dried and then sifted through a sieve in order to remove a coarse powder.

The polyethylene powder of the present embodiment may be a mixture of a plurality of polyethylene powders each containing the ethylenic polymer obtained by the production method mentioned above.

The polyethylene powder may be used, if necessary, in combination with an additive known in the art such as a slip agent, a neutralizer, an antioxidant, a light stabilizer, an antistatic agent, or a pigment.

Examples of the slip agent or the neutralizer include, but are not particularly limited to, aliphatic hydrocarbons, higher fatty acids, higher fatty acid metal salts, fatty acid esters of alcohols, waxes, higher fatty acid amides, silicone oil, and rosin. Specific examples of the suitable additive can include stearate such as stearate calcium stearate, magnesium stearate, and zinc stearate.

The antioxidant is not particularly limited and is preferably, for example, a phenol compound or a phenol-phosphorus compound, specifically include: phenol antioxidants such as 2,6-di-t-butyl-4-methylphenol(dibutylhydroxytoluene), n-octadecyl-3-(4-hydroxy-3,5-di-t-butylphenyl)propionate, and tetrakis(methylene(3,5-di-t-butyl-4-hydroxyhydrocinnamate))methane; phenol-phosphorus antioxidants such as 6-[3-(3-t-butyl-4-hydroxy-5-methylphenyl)propoxy]-2,4,8,10-tetra-t-butyldibenzo[d,f][1,3,2]dioxaphosphepin; and phosphorus antioxidants such as tetrakis(2,4-di-t-butylphenyl)-4,4′-biphenylene-di-phosphonite, tris(2,4-di-t-butylphenyl)phosphite, and cyclic neopentane tetraylbis(2,4-di-t-butylphenyl phosphite).

Examples of the light stabilizer include, but are not particularly limited to: benzotriazole light stabilizers such as 2-(5-methyl-2-hydroxyphenyl)benzotriazole and 2-(3-t-butyl-5-methyl-2-hydroxyphenyl)-5-chlorobenzotriazole; and hindered amine light stabilizers such as bis(2,2,6,6-tetramethyl-4-piperidine)sebacate and poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}].

Examples of the antistatic agent include, but are not particularly limited to, aluminosilicate, kaolin, clay, natural silica, synthetic silica, silicates, talc, diatomaceous earth, and glycerin fatty acid ester.

### [Purpose]

The polyethylene powder of the present embodiment can be used as a starting material for various molded articles such as microporous membranes, fibers, particularly, high-strength fibers, sintered compacts, pressed molded articles, and ram extrudates.

The polyethylene powder of the present embodiment is particularly suitable as a starting material for a microporous membrane for a battery separator.

### [Molded Article]

The molded article of the present embodiment is a molded article of the polyethylene powder of the present embodiment mentioned above.

Examples of the molded article include, but are not particularly limited to, microporous membranes, particularly, microporous membranes serving as battery separators, fibers, particularly, high-strength fibers, sintered compacts, pressed molded articles, and ram extrudates.

Examples of the method for producing the molded article include, but are not particularly limited to, a molding method through the steps of resin extrusion using a wet extrusion method, drawing, extraction, and drying.

Examples of the battery separator mentioned above include, but are not particularly limited to, separators for lithium ion secondary batteries and separators for lead storage batteries.

### EXAMPLES

Hereinafter, the present embodiment will be described in more detail with reference to specific Examples and Comparative Examples. However, the present invention is not limited by Examples and Comparative Examples given below by any means.

First, methods for evaluating the physical properties of each polyethylene powder will be described.

### [Physical Properties of Polyethylene Powder]

### (Viscosity-Average Molecular Weight (Mv))

The viscosity-average molecular weight of the polyethylene powder was measured by the following method in accordance with ISO1628-3 (2010).

The polyethylene powder was weighed in the range of 4.0 to 4.5 mg into a dissolution tube. The weighed mass is indicated by “m (unit: mg)” in mathematical expressions given below. Next, the air inside the dissolution tube was evacuated with a vacuum pump and purged with nitrogen, and 20 mL of decahydronaphthalene (supplemented with 1 g/L 2,6-di-t-butyl-4-methylphenol, deaerated with a vacuum pump, and purged with nitrogen; hereinafter, referred to as decalin) was then added thereto. The polyethylene powder was dissolved by stirring at 150° C. for 90 minutes to prepare a decalin solution.

Then, the decalin solution was added to a Cannon-Fenske viscometer (manufactured by Sibata Scientific Technology Ltd./viscometer No. 100) in a constant-temperature liquid bath of 135° C., and the falling time (tₛ) between the marked lines was measured.

The falling time (t_{b}) of only decalin to which the polyethylene powder was not added, as a blank, was measured, and the specific viscosity (ηₛₚ) was determined according to the following (Mathematical Expression A).

$${η}_{s p} = ( {t}_{s} / {t}_{b} ) - 1 \qquad ( Mathematical Expression A )$$

From the specific viscosity (ηₛₚ) and the concentration (C) (unit: g/dL), the intrinsic viscosity IV ([η]) was calculated according to the following (Mathematical Expression B) and (Mathematical Expression C).

$$Concentration C = m / ( 20 \times γ ) / 10 ( unit : g / dL ) \qquad ( Mathematical Expression B )$$

$$γ = ( Density of decalin at 20 ° C . ) / ( Density of decalin at 135 ° C . ) = 0.888 / 0.802 = 1.107$$

$$Intrinsic viscosity IV = ( {η}_{sp} / C ) / ( 1 + 0.27 \times {η}_{sp} ) \qquad ( Mathematical Expression C )$$

This intrinsic viscosity IV was substituted into the following (Mathematical Expression D) to determine a viscosity-average molecular weight (Mv).

$$Viscosity - average molecular weight ( Mv ) = ( 5.34 \times {10}^{4} ) \times {[ η ]}^{1.49} \qquad ( Mathematical Expression D )$$

### (Temperature Difference Between Peak Top Temperature and Peak Convergence Point in DSC Curve of Second Heating Process (Crystal Thickness Parameter))

The crystal thickness parameter was determined by the following method using a differential scanning calorimeter (manufactured by PerkinElmer, Inc./product name: DSC8000).

First, aluminum pan containing 8.5 mg of the polyethylene powder was placed in a heating furnace in the DSC apparatus, and heating operation was performed in accordance with <Measurement conditions> given below. However, the heating operation was performed in a nitrogen atmosphere.

### <Measurement Conditions>

(1) left standing at 50° C. for 1 min,
(2) heated from 50° C. to 180° C. at 10° C./min (first heating),
(3) left standing at 180° C. for 5 min,
(4) cooled from 180° C. to 50° C. at 10° C./min,
(5) left standing at 50° C. for 5 min, and
(6) heated from 50° C. to 180° C. at 10° C./min (second heating).

Then, the temperature that indicated the peak top (Tm2ₜₒₚ) and the peak convergence point (Tm2_{end}) were determined as to an endothermic peak obtained in the second heating process.

Finally, the value of each temperature was substituted into the following (Mathematical Expression E), the temperature difference between the peak top temperature and the peak convergence point in the DSC curve of the second heating process (crystal thickness parameter) was calculated.

$$( Temperature difference ) = Tm {2}_{end} - Tm {2}_{top} \qquad ( Mathematical Expression E )$$

Tm2_{end} was calculated by the following procedures.

### <Procedures of Calculating Tm2_{end}>

(1) The amount of heat absorbed obtained in the second heating process is differentiated based on a temperature.
(2) The temperature at which the absolute value of the differential value obtained in (1) first reached 0.01 or less counted from Tm2ₜₒₚ was regarded as Tm2_{end}.
   (z-Average Shrinkage Factor g_{z})

The z-average shrinkage factor g_{z} was calculated by the following method using a gel permeation chromatography (GPC) measurement apparatus (manufactured by Agilent Technologies, Inc./product name: PL-GPC220) equipped with a differential refractometer (RI) and a viscosity detector (viscometer).

First, a predetermined amount of the polyethylene powder was added to 1,2,4-trichlorobenzene (manufactured by FUJIFILM Wako Pure Chemical Corp.; supplemented with the antioxidant 4,4′-thiobis(2-t-butyl-5-methylphenol) at a concentration of 125 mg/L). In this respect, the concentration was adjusted as shown in the following

### <Sample Concentration>.

### <Sample Concentration>

Mv of smaller than 300000: 10 mg/10 mL
Mv of 300000 or larger and smaller than 1000000: 3 mg/10 mL
Mv of 1000000 or larger and smaller than 2000000: 2 mg/10 mL
Mv of 2000000 or larger and smaller than 3000000: 1.5 mg/10 mL
Mv of 3000000 or large: 1.5 mg/15 mL

Further, the prepared sample solution was shaken by heating in accordance with <Dissolution conditions> given below. The sample solution after dissolution was placed, without being cooled, in an autosampler heated to 160° C.

### <Dissolution Conditions>

(1) left standing for 1 hour while heated to 150° C.,
(2) shaken for 2 hours while heated to 150° C., and
(3) left standing for 30 minutes while heated to 150° C.

Next, measurement was carried out in accordance with the following <GPC measurement conditions>.

### <GPC Measurement Conditions>

Differential refractometer (RI): built-in
Viscosity detector (viscometer): PL-BV400 model
Detector connection method: connected in parallel
Column: PLgel 20 μm MIXED-A 300×7.5 mm (manufactured by Agilent Technologies, Inc.)
Column connection method: two columns mentioned above connected in series
Mobile phase: 1,2,4-trichlorobenzene (manufactured by FUJIFILM Wako Pure Chemical Corp.; supplemented with the antioxidant 4,4′-thiobis(2-t-butyl-5-methylphenol) at a concentration of 125 mg/L)
Column temperature: 160° C.
Detector temperature: 160° C.
Sample solution temperature: 160° C.
Sample injection part temperature: 160° C.
Amount of sample injected: 0.5 mL
Flow rate: 1.0 mL/min
Column calibration was carried out by the universal calibration method using the following <Sample for calibration curve preparation>.

### <Sample for Calibration Curve Preparation>

EasiVial™ PS-H Polystyrene (High MW) manufactured by Agilent Technologies, Inc.
PL Polymer Standard (product No: PL2013-6001) manufactured by Agilent Technologies, Inc.
PL Polymer Standard (product No: PL2014-9001) manufactured by Agilent Technologies, Inc.

Next, the data obtained by measurement under the conditions mentioned above was analyzed using CIRRUS GPC/SEC Software (version 3.4) manufactured by Agilent Technologies, Inc. to prepare Mark-Houwink Plot (double logarithmic graph of the molecular weight MW plotted on the abscissa against the intrinsic viscosity IV on the ordinate). In this plot, fitting was performed according to the following (Mathematical Expression F) as to a region on a lower molecular weight side than the peak top molecular weight and where the double logarithmic graph has a straight line, to prepare a straight baseline shown in (Mathematical Expression G).

$${log}_{10} IV = a {log}_{10} M W + {log}_{10} C \qquad ( Mathematical Expression F )$$

$${log}_{10} IV = {a}_{linear} {log}_{10} M W + {log}_{10} {C}_{linear} \qquad ( Mathematical Expression G )$$

In Mathematical Expressions F and G, a and C are variables at the time of fitting, and both aₗᵢₙₑₐᵣ and Cₗᵢₙₑₐᵣ are constants obtained by fitting.

Subsequently, g′ and g′_{z} were calculated according to the following (Mathematical Expression H) and (Mathematical Expression I) using the values of the intrinsic viscosity IVₛₐₘₚₗₑ of a sample and the intrinsic viscosityIVₗᵢₙₑₐᵣ of the straight baseline at the same molecular weight.

$${g}^{′} = {IV}_{sample} / {IV}_{linear} \qquad ( Mathematical Expression H )$$

$${g}_{z}^{′} = Σ ( {Conc}_{i} \times M {W}_{i} \times {g}_{i}^{′} ) / Σ ( {Conc}_{i} \times M {W}_{i} ) \qquad ( Mathematical Expression I )$$

In Mathematical Expression I, Concᵢ is a solution concentration in the ith fraction, MWᵢ is a molecular weight in the ith fraction, and g′_{I} is g′ in the ith fraction.

Finally, the z-average shrinkage factor g_{z} was calculated according to the following (Mathematical Expression J).

$$z - average shrinkage factor {g}_{z} = {g}_{z}^{′ ( 1 / 0.75 )} \qquad ( Mathematical Expression J )$$

### (Drawability Evaluation)

The drawability was evaluated by the following method using Labo Plastomill Mixer (unit model: 30C150, mixer model: R-60) manufactured by Toyo Seiki Co., Ltd. and a simultaneous biaxial drawing machine.

First, in a resin container, 12 g of the polyethylene powder, 0.4 g of the antioxidant pentaerythritol tetrakis[3-(3,5-di-tert-butyl-4-hydroxyphenyl)propionate](product name: Adekastab AO-60G) manufactured by ADEKA Corp., and 28 g of liquid paraffin (product name: P-350P) manufactured by MORESCO Corp. were well mixed to obtain a mixture.

Next, the mixture mentioned above was added to Labo Plastomill Mixer (manufactured by Toyo Seiki Co., Ltd., unit model: 30C150, mixer model: R-60) set to a temperature of 200° C., kneaded for 10 minutes under conditions involving a rotational speed of 5 rpm, and subsequently further kneaded under conditions involving a rotational speed of 50 rpm to obtain a polyethylene gel. This gel was molded into a sheet on the basis of the following <Gel sheet preparation conditions>.

### <Gel Sheet Preparation Conditions>

(1) The polyethylene gel mentioned above was filled into a 200 mm×200 mm×1 mm thick mold.
(2) The mold was preheated at 1 kg/cm² for 3 minutes in a press with a temperature set to 180° C., and defoaming operation was performed three times, followed by pressing at 10 kg/cm² for 2 minutes.
(3) The mold was cooled at 10 kg/cm² for 10 minutes in a cold press of room temperature.
(4) The resultant was cut to obtain a 100 mm×100 mm×1 mm thick gel sheet.

The gel sheet thus obtained was drawn at a ratio of 7×7 at 115° C. using a simultaneous biaxial drawing machine to obtain a drawn film. In this respect, the drawability was evaluated in accordance with the following (Drawability evaluation criteria).

### (Drawability Evaluation Criteria)

◯ (pass): The film was not ruptured.
X (fail): The film was ruptured.
   (Absorption Coefficient at 400 cm⁻¹ to 450 cm⁻¹)

The absorption coefficient at 400 cm⁻¹ to 450 cm⁻¹ was measured by the following method (terahertz measurement) using a Fourier transform far-infrared spectroscopic apparatus (manufactured by JASCO Corp., model: VIR-F4000).

First, the polyethylene powder was molded into a sheet on the basis of the following <Pressing conditions> using an automatic heat press (manufactured by Shinto Metal Industries, Ltd., model: SFA-37H) and a manual cold press (manufactured by Oji Machine Co., Ltd., model: J-37).

### <Pressing Conditions>

(1) 8 g of the polyethylene powder was filled into a 50 mm×50 mm×2 mm thick mold.
(2) The mold was preheated at 5 kg/cm² for 5 minutes in the automatic heat press with a temperature set to 210° C., and defoaming operation was performed three times, followed by pressing at 15 kg/cm² for 25 minutes.
(3) The mold was cooled at 10 kg/cm² for 10 minutes in the manual cold press of room temperature to obtain a sheet.

Next, a disc of 20 mm in diameter was punched out in the obtained sheet to obtain a measurement sample. This measurement sample was measured under the following <Terahertz measurement conditions> using a Fourier transform far-infrared spectroscopic apparatus (manufactured by JASCO Corp., model: VIR-F4000).

### <Terahertz Measurement Conditions>

Wavenumber region: 50 to 600 cm⁻¹
Measurement environment: in atmosphere, room temperature (25° C.)
Light source: ceramic
Beam diameter: approximately 8 to 9 mm
Holder hole diameter: 10 mm

Based on incident light intensity I₀ and transmitted light intensity I obtained under the measurement conditions described above, the absorption coefficient at each wavenumber was calculated according to the following (Mathematical Expression K) to calculate an absorption coefficient at 400 cm⁻¹ to 450 cm⁻¹.

$$α = - {log}_{10} ( {I}_{0} / I ) / 0.4343 x \qquad ( Mathematical Expression K )$$

α: Absorption coefficient [cm⁻¹]
I₀: Intensity of electromagnetic wave before incidence
I: Intensity of electromagnetic wave after incidence (transmitted light intensity)
x: Sample thickness [cm]

### (¹H-NMR Measurement)

¹H-NMR was determined by the following method using a nuclear magnetic resonance apparatus (manufactured by Bruker/product name: AvanceNE0600).

First, measurement was performed in accordance with the following <NMR measurement conditions>.

### <NMR Measurement Conditions>

Observed nucleus: ¹H
Observation frequency: 600 MHz
Pulse program: zg30
Pulse waiting time: 1 sec
The number of scans: 1024 times
Measurement temperature: 130° C.
Chemical shift reference: 7.219 ppm (o-DCBz)
Sample concentration: 1 wt %
Sample tube: 5 mmϕ

Next, the presence or absence of a signal (peak) was confirmed in two regions of (1) 4.8 ppm to 5.0 ppm and (2) 5.6 ppm to 6.0 ppm as to the obtained data.

### (Aluminum Content and Silicon Content)

The element contents of the polyethylene powder were measured by high-frequency plasma mass spectrometry in accordance with JIS K 0133. Sample preparation was carried out by pressure acid decomposition with nitric acid using a microwave decomposition apparatus (model ETHOS TC, manufactured by Milestone General K.K.). The aluminum content and the silicon content in the polyethylene powder were measured as to the prepared sample by the internal standard method using ICP-MS (inductively coupled plasma-mass spectrometer, model X Series X7, manufactured by Thermo Fisher Scientific K.K.).

### (Peak Top Temperature in DSC Curve of Second Heating Process)

The temperature that indicated the peak top (Tm2ₜₒₚ) in the DSC curve of the second heating process was determined in DSC measurement for determining the above (Temperature difference between peak top temperature and peak convergence point in DSC curve of second heating process).

### (Density)

The density of the polyethylene powder was determined by the following procedures (1) to (7).
(1) The polyethylene powder was filled into a 100 mm×100 mm×2 mm thick mold.
(2) The mold was preheated at 10 kg/cm² for 3 minutes in a press with a temperature set to 190° C., and defoaming operation was performed three times, followed by pressing at 15 kg/cm² for 2 minutes.
(3) The mold was cooled to room temperature in a cold press to obtain a pressed sheet.
(4) The obtained pressed sheet was cut into a 20 mm×20 mm×2 mm thick piece.
(5) The cut piece was added to a test tube and heated at 120° C. for 1 hour in a nitrogen atmosphere.
(6) The piece thus heated was cooled at 20° C. for 1 hour to obtain a molded article sample for density measurement.
(7) The density of the molded article sample was measured in accordance with JIS K 7112: 1999 (Method D), and the obtained value was regarded as the density (kg/m³) of the polyethylene powder.
   (Content (Mol) of Central Metal M Contained in Transition Metal Compound Component [B-1] and/or Transition Metal Compound Component [B-2] in Catalytic Component and Molar Ratio (Al/M) of Content (Mol) of Al to Content (Mol) of Central Metal M)

The element contents in a catalytic component was measured using a microwave plasma atomic emission spectroscopic apparatus (manufactured by Agilent Technologies, Inc., model: 4210 MP-AES/G8007A).

First, an acid decomposition solution of the catalytic component was prepared on the basis of the following <Decomposition conditions>.

### <Decomposition Conditions>

(1) Under a nitrogen atmosphere, 100 mg to 500 mg of the catalytic component is weighed into a pressure-resistant container.
(2) 10 mL of sulfuric acid (1+1) is added to the pressure-resistant container of (1) and stirred for 1 hour or longer.
(3) The aqueous solution obtained in (2) is brought up to 100 mL.
(4) A 2 mL to 20 mL aliquot is separated from the aqueous solution obtained in (3), and further brought up to 100 mL. The amount of the aliquot is appropriately adjusted according to the amount of light emitted in measurement mentioned later.

Next, the content (mol) of the central metal M and the content (mol) of Al contained in the transition metal compound component [B-1] and/or the transition metal compound component [B-2] in the catalytic component were determined as to the obtained acid decomposition solution on the basis of the following <MP-AES measurement conditions> by the external standard method using a microwave plasma atomic emission spectroscopic apparatus (manufactured by Agilent Technologies, Inc., model: 4210 MP-AES/G8007A), and their molar ratio (Al/M) was calculated.

### <MP-AES Measurement Conditions>

Standard solution for apparatus calibration: ICP-OES & MP-AES Wavecal: Al, As, Ba, Cd, Co, Cr, Cu, Mn, Mo, Ni, Pb, Se, Sr, and Zn (5 mg/L); K (50 mg/L) in 5% HNO₃
Background correction: auto
Lead time: 3 s
Observation position: 0
Nebulizer flow rate: M (0.5 to 1.0 L/min), Al (0.95 L/min)
The number of repeats of measurement: 3
Pump speed: 15 rpm
Incorporation time: 15 s
Stabilization time: 15 s
The number of pixels: 3
Standard solution for calibration curve preparation: standard solution for atomic spectroscopy (manufactured by Kanto Chemical Co., Inc.) corresponding to each element
Calibration curve concentration: 8 points: 0.5 mg/L, 1 mg/L, 2 mg/L, 5 mg/L, 10 mg/L, 20 mg/L, 50 mg/L, and 100 mg/L

### [Production of Microporous Membrane and Evaluation of Characteristics]

### (Method for Producing Microporous Membrane)

First, in a resin container, 12 g of the polyethylene powder of each of Examples and Comparative Examples, 0.4 g of the antioxidant pentaerythritol tetrakis[3-(3,5-di-tert-butyl-4-hydroxyphenyl)propionate](product name: Adekastab AO-60G) manufactured by ADEKA Corp., and 28 g of liquid paraffin (product name: P-350P) manufactured by MORESCO Corp. were well mixed to obtain a mixture.

Next, the mixture mentioned above was added to Labo Plastomill Mixer (manufactured by Toyo Seiki Co., Ltd., unit model: 30C150, mixer model: R-60) set to a temperature of 200° C., kneaded for 10 minutes under conditions involving a rotational speed of 5 rpm, and subsequently further kneaded for 10 minutes under conditions involving a rotational speed of 50 rpm to obtain a polyethylene gel. This gel was molded into a sheet on the basis of the following <Gel sheet preparation conditions>.

### <Gel Sheet Preparation Conditions>

(1) The polyethylene gel mentioned above was filled into a 200 mm×200 mm×1 mm thick mold.
(2) The mold was preheated at 1 kg/cm² for 3 minutes in a press with a temperature set to 180° C., and defoaming operation was performed three times, followed by pressing at 10 kg/cm² for 2 minutes.
(3) The mold was cooled at 10 kg/cm² for 10 minutes in a cold press of room temperature to obtain a gel sheet.

The gel sheet thus obtained was drawn at a ratio of 7×7 at 115° C. (for polyethylene having a viscosity-average molecular weight of 100000 or large and smaller than 2500000) or 120° C. (for polyethylene having a viscosity-average molecular weight of 2500000 or larger and 4000000 or smaller) using a simultaneous biaxial drawing machine to obtain a drawn film. The dipping of this drawn film in normal hexane for 20 minutes was repeated twice to remove liquid paraffin by extraction, followed by air drying. Further, heat setting was performed at 125° C. for 3 minutes to obtain a microporous membrane.

However, the drawing temperature and the heat setting temperature were appropriately adjusted on a microporous membrane basis within designated temperature ranges.

### (Evaluation of Heat Resistance of Microporous Membrane)

The microporous membrane was evaluated for its rate of heat shrinkage at a high temperature as an evaluation index for heat resistance.

Specifically, eight 100 mm×50 mm membranes were punched out in a 250 mm×250 mm site of the microporous membrane obtained by the above [Method for producing microporous membrane], and left standing for 60 minutes in an oven set to 140° C.

The membranes thus heated and left standing were cooled at room temperature for 15 minutes. Then, the dimensions of the microporous membranes were measured, and the rates of heat shrinkage (%) were calculated according to the expression given below.

Then, an average of a total of eight measurement values was calculated, and the heat resistance was evaluated according to the evaluation criteria given

$$( Rate of heat shrinkage ) = ( ( Rate of heat shrinkage in the long - side direction ) + ( Rate of heat shrinkage in the short - side direction ) ) / 2$$

$$( Rate of heat shrinkage in the long - side direction ) = ( 1 - {D}_{long side 140} / {D}_{long side 23} ) \times 100$$

$$( Rate of heat shrinkage in the short - side direction ) = ( 1 - {D}_{short side 140} / {D}_{short side 23} ) \times 100$$

D_{long side140}: Dimension [mm] in the long-side direction at 140° C.
D_{long side23}: Dimension [mm] in the long-side direction at 23° C.
D_{short side140}: Dimension [mm] in the short-side direction at 140° C.
D_{short side23}: Dimension [mm] in the short-side direction at 23° C.

### (Evaluation Criteria)

⊚ (good): less than 40%
◯ (fair): 40% or more and less than 50%
X (poor): 50% or more

### (Evaluation of Homogeneity of Microporous Membrane)

The microporous membrane was evaluated for its thickness homogeneity as an evaluation index for homogeneity.

Specifically, eight 100 mm×50 mm membranes were punched out in a 250 mm×250 mm site of the microporous membrane obtained by the above [Method for producing microporous membrane]. The film thickness of each membrane was measured under a condition of 23° C. using a micro thickness gauge (model: KBM) manufactured by Toyo Seiki Co., Ltd. The film thickness measurement was carried out at three locations per punched membrane.

Then, a standard deviation of a total of 24 measurement values was calculated, and the homogeneity was evaluated according to the following evaluation criteria.

### (Evaluation Criteria)

⊚ (good): less than 0.5 μm
◯ (fair): 0.5 μm or more and less than 1 μm
X (poor): 1 μm or more

### (Evaluation of Dimensional Stability of Microporous Membrane)

The microporous membrane was evaluated for its rate of heat shrinkage as an evaluation index for dimensional stability.

Specifically, eight 100 mm×50 mm membranes were punched out in a 250 mm×250 mm site of the microporous membrane obtained by the above [Method for producing microporous membrane], and left standing for 60 minutes in an oven set to 120° C.

The membranes thus heated and left standing were cooled at room temperature for 15 minutes. Then, the dimensions of the microporous membranes were measured, and the rates of heat shrinkage (%) were calculated according to the expression given below.

Then, an average of a total of eight measurement values was calculated, and the dimensional stability was evaluated according to the evaluation criteria given below.

$$( Rate of heat shrinkage ) = ( ( Rate of heat shrinkage in the long - side direction ) + ( Rate of heat shrinkage in the short - side direction ) ) / 2$$

$$( Rate of heat shrinkage in the long - side direction ) = ( 1 - {D}_{long side 120} / {D}_{long side 23} ) \times 100$$

$$( Rate of heat shrinkage in the short - side direction ) = ( 1 - {D}_{short side 120} / {D}_{short side 23} ) \times 100$$

D_{long side120}: Dimension [mm] in the long-side direction at 120° C.
D_{long side23}: Dimension [mm] in the long-side direction at 23° C.
D_{short side120}: Dimension [mm] in the short-side direction at 120° C.
D_{short side23}: Dimension [mm] in the short-side direction at 23° C.

### (Evaluation Criteria)

⊚ (good): less than 10%
◯ (fair): 10% or more and less than 20%
X (poor): 20% or more

### (Evaluation of Rate of Enhancement in Heat Resistance of Microporous Membrane)

A microporous membrane obtained using 12 g of high-density polyethylene “SH800” (TM, manufactured by Asahi Kasei Corp.) having a viscosity-average molecular weight (Mv) of 300000 instead of 12 g of the polyethylene powder of each of Examples and Comparative Examples in the above (Method for producing microporous membrane), and a microporous membrane obtained using 8.4 g of high-density polyethylene “SH800” (TM, manufactured by Asahi Kasei Corp.) having a viscosity-average molecular weight (Mv) of 300000 and 3.6 g of the polyethylene powder of each of Examples and Comparative Examples instead of 12 g of the polyethylene powder of each of Examples and Comparative Examples in the above (Method for producing microporous membrane) were evaluated by the method described in the above (Evaluation of heat resistance of microporous membrane). Then, their rates of enhancement in heat resistance were evaluated according to the evaluation criteria given below.

$$( Rate of enhancement in heat resistance ) = ( 1 - {S}_{after addition} / {S}_{before addition} ) \times 100$$

S_{after addition}: Rate of heat shrinkage [%] of the microporous membrane supplemented with the polyethylene powder of each of Examples and Comparative Examples
S_{before addition}: Rate of heat shrinkage [%] of the microporous membrane obtained using only high-density polyethylene “SH800”.

### (Evaluation Criteria)

⊚ (good): 20% or more
◯ (fair): 10% or more and less than 20%
X (poor): less than 10%

### [Preparation of Catalytic Component]

(Solid Particle [A]: Preparation of (a-1) to (a-3))

Inorganic solid particles (a-1) to (a-3) were prepared in accordance with the following (1) and (2).

(Preparation of Inorganic Solid Particle (a-1))

### <(1) Synthesis of Organic Magnesium Compound (A-1)>

An 8 L stainless autoclave thoroughly purged with nitrogen was charged with 2,000 mL of a hexane solution containing 1 mol/L Mg₆(C₄H₉)₁₂Al(C₂H₅)₃ (corresponding to 2000 mmol in total of magnesium and aluminum). From a feed line connected to the autoclave, 146 mL of a hexane solution containing 5.47 mol/L n-butanol was added dropwise over 3 hours with stirring at 50° C. After the completion of the dropwise addition, the line was washed with 300 mL of hexane. The stirring was further continued at 50° C. over 2 hours. After the completion of the reaction, the reaction solution was cooled to ordinary temperature and used as a starting material (A-1). The starting material (A-1) was an organic magnesium compound having a magnesium concentration of 0.704 mol/L.

<(2) Synthesis of Inorganic Solid Particle (a-1)>

An 8 L stainless autoclave thoroughly purged with nitrogen was charged with 1,000 mL of a hexane solution containing 1 mol/L trichlorosilane. To this autoclave, 1340 mL of a hexane solution of the organic magnesium compound as the starting material (A-1) (corresponding to 943 mmol of magnesium) was added dropwise at 65° C. over 3 hours, and the reaction was further continued with stirring at 65° C. for 1 hour. After the completion of the reaction, the supernatant was removed, and the resulting solid was washed with 1,800 mL of hexane four times to obtain an inorganic solid particle (a-1) (magnesium chloride particle). As a result of analyzing this particle, the amount of magnesium contained per g of the solid was 7.5 mmol.

(Preparation of Inorganic Solid Particle (a-2))

An 8 L stainless autoclave thoroughly purged with nitrogen was charged with 130 g of heat-treated silica (manufactured by Fuji Silysia Chemical Ltd./product name: Q-6) and 2500 mL of hexane to obtain slurry. While the temperature of the obtained slurry was kept at 20° C. with stirring, 260 mL of 1 mol/L methylaluminoxane (toluene solution, manufactured by Tosoh Finechem Corp.) was added thereto. Then, the reaction was continued with stirring for 2 hours. After the completion of the reaction, the supernatant was removed, and the resulting solid was washed with 1,800 mL of hexane four times to obtain an inorganic solid particle (a-2).

(Preparation of Inorganic Solid Particle (a-3))

A 300 mL glass container thoroughly purged with nitrogen was charged with 10 g of heat-treated silica (manufactured by Grace Davision/product name: Sylopol952) and 100 mL of toluene to obtain slurry. While the temperature of the obtained slurry was kept at 80° C. with stirring, 90 mL of 1 mol/L methylaluminoxane (toluene solution, manufactured by Tosoh Finechem Corp.) was added thereto, followed by stirring for 1 hour. The temperature of the container thus stirred was brought to room temperature by cooling, and 40 mL of 1 mol/L methylaluminoxane (toluene solution, manufactured by Tosoh Finechem Corp.) was added thereto. The reaction was further continued with stirring for 1 hour. After the completion of the reaction, the supernatant was removed, and the resulting solid was washed with 100 mL of toluene four times to obtain an inorganic solid particle (a-3)

(Transition Metal Compound Component [B-2]: Preparation of (b-1))

In a 3 L glass container thoroughly purged with nitrogen, 200 mmol of [(N-t-butylamido) (tetramethyl-η5-cyclopentadienyl)dimethylsilane]titanium-1,3-pentadiene was dissolved in 1000 ml of Isopar E [manufactured by Exxon Chemical Co., Inc.]. To this solution, 40 ml of 1 mol/L ethyl butyl magnesium (hexane solution) was added. The titanium complex concentration was adjusted to 0.08 mol/L by the addition of hexane to obtain a transition metal compound component (b-1).

(Activating Agent [C]: Preparation of (c-1))

In a 500 mL glass container thoroughly purged with nitrogen, 17.8 g of bis(hydrogenated tallow alkyl)methylammonium-tris(pentafluorophenyl) (4-hydroxyphenyl) borate was added to 156 ml of toluene and dissolved therein to obtain a toluene solution containing 100 mM borate. While the temperature of this toluene solution of the borate was kept at 25° C., 15.6 ml of 1 mol/L diethylaluminum ethoxide (hexane solution) was added thereto. The borate concentration was adjusted to 0.08 mol/L by the addition of hexane. Then, the mixture was stirred at 25° C. for 1 hour to prepare an activating agent (c-1).

(Organic Metal Compound Component [D]: Synthesis of (d-1))

An 8 L stainless autoclave thoroughly purged with nitrogen was charged with 2,000 mL of a hexane solution containing 1 mol/L Mg₆(C₄H₉)₁₂Al(C₂H₅)₃ (corresponding to 2000 mmol in total of magnesium and aluminum), and pressure-fed with 240 mL of a hexane solution containing 8.33 mol/L methyl hydrogen polysiloxane (manufactured by Shin-Etsu Chemical Co., Ltd.) with stirring at 80° C., and the reaction was further continued with stirring at 80° C. over 2 hours. After the completion of the reaction, the reaction solution was cooled to ordinary temperature and used as an organic metal compound component (d-1). The organic metal compound component (d-1) had a concentration of 0.786 mol/L in total of magnesium and aluminum.

### Example 1

### (Preparation of Catalytic Component (A))

In a 50 mL glass container thoroughly purged with nitrogen, 0.0011 mmol of bis(pentamethylcyclopentadienyl)titanium dichloride (Cp*₂TiCl₂) was dissolved in 3 mL of toluene. To this solution, 1.42 mol/L modified methylaluminoxane (MMAO, hexane solution, manufactured by Tosoh Finechem Corp.) was added thereto and reacted at 25° C. for 1 hour to obtain an active species (A1).

Next, while the temperature of 10 mL of hexane slurry containing 0.44 g of the inorganic solid particle (a-1) was kept at 25° C., the whole amount of the solution of the active species (A1) was added thereto and reacted for 1 hour. After the completion of the reaction, the supernatant was removed, and unreacted starting material components were removed by washing with hexane four times. This reaction formed a layer of the active species (A1) on the surface of the inorganic solid particle (a-1). Further, 1.4 mL of the transition metal compound component (b-1) and 1.4 mL of the activating agent (c-1) were added thereto at the same time and reacted for 2 hours. After the completion of the reaction, the supernatant was removed, and unreacted starting material components were removed by washing with hexane four times to obtain a catalytic component (A). A two-layer structure was formed on the surface of the inorganic solid particle (a-1) by the supporting of the active species (A1) followed by the supporting of the transition metal compound component (b-1) and the activating agent (c-1) (multistage supporting) as described above.

### Examples 2 to 9 and Comparative Examples 2, 5, and 6

### (Preparation of Catalytic Components (B) to (H), (J), (M), (N), and (E′))

Catalytic components (B) to (H), (J), (M), (N), and (E′) were prepared in the same manner as the method for preparing the catalytic component (A) except that the catalyst synthesis conditions were changed as described in Tables 1 and 2.

### Example 10

### (Preparation of Catalytic Component (0))

A catalytic component (0) was prepared in the same manner as the method for preparing the catalytic component (A) except that the catalyst synthesis conditions were changed as described in Table 1; and the reaction temperature in the premixing step to obtain the active species (A1) was set to 90° C.

### Comparative Example 1

### (Preparation of Catalytic Component (I))

In a 50 mL glass container thoroughly purged with nitrogen, while the temperature of 10 mL of toluene slurry containing 1 g of the inorganic solid particle (a-3) was kept at 40° C., 0.1 mmol of bis(n-butylcyclopentadienyl) zirconium dichloride (nBuCp₂ZrCl₂) dissolved in advance in toluene was added thereto and reacted for 1 hour. Further, 0.1 mmol of [(N-t-butylamido) (tetramethyl-η5-cyclopentadienyl)dimethylsilane]titanium dichloride (b-2) dissolved in advance in toluene was added thereto and reacted for 1 hour. Finally, 0.2 mmol of N,N′-dimethylanilinium tetrakis(pentafluorophenyl) borate (c-2) dissolved in advance in toluene was added thereto and reacted for 1 hour. After the completion of the reaction, the supernatant was removed, and unreacted starting material components were removed by washing with toluene four times. Then, toluene was removed by vacuum drying to prepare a catalytic component (I).

### Comparative Example 3

### (Preparation of Catalytic Component (K))

To 1,970 mL of hexane slurry containing 110 g of the inorganic solid particle (a-1), 103 mL of a hexane solution containing 1 mol/L titanium tetrachloride and 131 mL of the organic metal compound component (d-1) were added at the same time over 3 hours with stirring at 10° C. After the addition, the reaction was continued at 10° C. for 1 hour. After the completion of the reaction, the supernatant was removed, and unreacted starting material components were removed by washing with hexane four times to prepare a catalytic component (K).

### Comparative Example 4

### (Preparation of Catalytic Component (L))

To an 8 L stainless autoclave thoroughly purged with nitrogen, 1,600 mL of hexane was added. To this autoclave, 800 mL of a hexane solution containing 1 mol/L titanium tetrachloride and 1017 mL of the organic metal compound component (d-1) were added at the same time over 2 hours with stirring at 40° C. After the addition, the reaction was continued at 40° C. for 1 hour by gradual heating. After the completion of the reaction, 1600 mL of the supernatant was removed, and a catalytic component (L) was prepared by washing with 1,600 mL of hexane four times.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Catalyst species | | | A | B | C | D | E | F | G |
| Catalyst | Trans- | First | Cp*₂TiCl₂ | Cp₂TiCl₂ | nBuCp₂ZrCl₂ | Cp*₂ZrCl₂ | b-1 | Cp₂TiCl₂ | Cp₂TiCl₂ |
| synthesis | ition | supporting | | | | | | | |
| con- | metal | Second | b-1 | b-1 | b-1 | b-1 | b-1 | b-1 | b-1 |
| ditions, | complex | supporting | | | | | | | |
| etc. | [B] | Second | 100 | 100 | 10 | 5 | 1 | 1000 | 1 |
| | | supporting/ | | | | | | | |
| | | First | | | | | | | |
| | | supporting | | | | | | | |
| | [C], [D] | First | MMAO | MMAO | MMAO | MMAO | c-1 | MMAO | MMAO |
| | | supporting | | | | | | | |
| | | Second | c-1 | c-1 | c-1 | c-1 | c-1 | c-1 | c-1 |
| | | supporting | | | | | | | |
| | First supporting | | 15 | 15 | 7 | 40 | 1 | 1.5 | 40 |
| | Molar ratio | | | | | | | | |
| | ([C] + [D])/[B] | | | | | | | | |
| | Second supporting | | 1 | 1 | 1 | 0.8 | 1 | 1 | 1 |
| | Molar ratio | | | | | | | | |
| | ([C] + [D])/[B] | | | | | | | | |
| | M content (μmol) | | 42 | 38 | 39 | 29 | 23 | 30 | 84 |
| | Molar ratio (Al/M) | | 20 | 23 | 28 | 26 | 1 | 18 | 15 |
| | Solvent | Type | Hexane | Toluene | Toluene | Hexane | Hexane | Hexane | Hexane |
| | Solid particle [A] | | a-1 | a-1 | a-1 | a-1 | a-1 | a-2 | a-1 |
| | Involving | | ◯ | ◯ | ◯ | ◯ | ◯ | ◯ | ◯ |
| | first supporting | | | | | | | | |
| | step and second | | | | | | | | |
| | supporting step | | | | | | | | |
| | Con- | Presence | ◯ | ◯ | X | ◯ | ◯ | ◯ | ◯ |
| | dition | or | | | | | | | |
| | 1 | absence | | | | | | | |
| | | of imple- | | | | | | | |
| | | mentation | | | | | | | |

| | | | Example | Example | Example |
|---|---|---|---|---|---|
| | | | 8 | 9 | 10 |
| Catalyst species | | | H | N | O |
| Catalyst | Trans- | First | nBuCp₂ZrCl₂ | b-2 | Cp₂TiCl₂ |
| synthesis | ition | supporting | | | |
| con- | metal | Second | b-2 | b-2 | b-2 |
| ditions, | complex | supporting | | | |
| etc. | [B] | Second | 0.5 | 1 | 1 |
| | | supporting/ | | | |
| | | First | | | |
| | | supporting | | | |
| | [C], [D] | First | MMAO | EtAlCl₂ | EtAlCl₂ |
| | | supporting | | | |
| | | Second | c-1 | EtAlCl₂ | EtAlCl₂ |
| | | supporting | | | |

| First supporting | | 80 | 15 | 26 |
|---|---|---|---|---|
| Molar ratio | | | | |
| ([C] + [D])/[B] | | | | |
| Second supporting | | 1 | 15 | 15 |
| Molar ratio | | | | |
| ([C] + [D])/[B] | | | | |
| M content (μmol) | | 61 | 69 | 119 |
| Molar ratio (Al/M) | | 14 | 3 | 4 |
| Solvent | Type | Hexane | Toluene | Toluene |

| Solid particle [A] | | a-1 | a-1 | a-1 |
|---|---|---|---|---|
| Involving | | ○ | ○ | ○ |
| first supporting | | | | |
| step and second | | | | |
| supportingstep | | | | |
| Con- | Presence | ○ | ○ | ○ |
| dition | or | | | |
| 1 | absence | | | |
| | of imple- | | | |
| | mentation | | | |

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Catalyst species | | | I | J | K | L | M | E′ |
| Catalyst | Transition | First supporting | nBuCp₂ZrCl₂ | Ti(OBu)₄ | — | — | nBuCp₂ZrCl₂ | — |
| | metal | Second | b-2 | TiCl4 | TiCl4 | TiCl4 | b-2 | b-1 |
| | | supporting | | | | | | |

| complex [B] | Second | 1 | — | — | — | 1 | — |
|---|---|---|---|---|---|---|---|
| | supporting/First | | | | | | |
| | supporting | | | | | | |
| [C], [D] | First supporting | MAO | Et₂AlCl | — | — | MAO | — |
| | Second | c-2 | EtAlCl₂ | d-1 | d-1 | — | c-1 |
| | supporting | | | | | | |
| First supporting | | 80 | 1 | — | — | 80 | — |
| Molar ratio ([C] + [D])/[B] | | | | | | | |
| Second supporting | | 2 | 1 | 1 | 1 | 2 | 1 |
| Molar ratio ([C] + [D])/[B] | | | | | | | |
| M content (μmol) | | 53 | 185 | 794 | 2590 | 75 | 11 |
| Molar ratio (Al/M) | | 40 | 0.6 | 0.2 | 0.1 | 40 | 1 |
| Solvent | Type | Toluene | Hexane | Hexane | Hexane | Toluene | Hexane |
| Solid particle [A] | | a-3 | a-1 | a-1 | X | a-3 | a-1 |
| Involving first supporting | | ◯ | ◯ | X | X | X | X |
| step and second supporting | | | | | | | |
| step | | | | | | | |
| Condition | Presence or | X | ◯ | X | X | ◯ | X |
| 1 | absence of | | | | | | |
| | implementation | | | | | | |

In Tables 1 and 2, a-1 to a-3 represent the inorganic solid particles (a-1) to (a-3) prepared as described above in order; b-1 represents the transition metal compound component (b-1) prepared as described above; b-2 represents [(N-t-butylamido) (tetramethyl-j5-cyclopentadienyl)dimethylsilane]titanium dichloride; c-1 represents the activating agent (c-1) prepared as described above; c-2 represents N,N′-dimethylanilinium tetrakis(pentafluorophenyl) borate; d-1 represents the organic metal compound component (d-1) synthesized as described above; Cp*₂TiCl₂ represents bis(pentamethylcyclopentadienyl)titanium dichloride; Cp₂TiCl₂ represents bis(cyclopentadienyl) titanium dichloride; nBuCp₂ZrCl₂ represents bis(n-butylcyclopentadienyl) zirconium dichloride; Cp*₂ZrCl₂ represents bis(pentamethylcyclopentadienyl)zirconium dichloride; TiCl₄ represents titanium tetrachloride; Ti(OBu)₄ represents titanium(IV) tetrabutoxide (monomer); EtAlCl₂ represents ethylaluminum dichloride; Et₂AlCl represents diethylaluminum chloride; MMAO represents modified methylaluminoxane; and MAO represents methylaluminoxane.

### [Production of Polyethylene Powder and Microporous Membrane]

### Example 11

### <Polymerization for Polyethylene Powder (A)>

Polymerization for a polyethylene powder was performed by the following method using a 1.5 L stainless autoclave polymerization reactor thoroughly purged with nitrogen.

First, the polymerization reactor heated to 60° C. was charged with 800 mL of hexane as a solvent, and 0.4 mmol of the organic metal compound component (d-1) was added thereto as a scavenger for impurities. Next, ethylene was added thereto such that the inside pressure was 0.65 MPa. The catalytic component (A) was added thereto in an amount of 1.25 μmol based on Ti. Further, hydrogen was added thereto in an amount of 0.5 mL per L of ethylene consumed. While the inside pressure and the inside temperature were kept at 0.65 MPa and 60° C., respectively, polymerization was performed for 30 minutes with stirring at a stirring speed of 1200 rpm. After the completion of the polymerization, the reaction mixture (polymer slurry) was discharged from the polymerization reactor, and the catalyst was inactivated with methanol. Then, the reaction mixture was filtered, washed, and dried in air to obtain a polyethylene powder (A). Polymerization activity in the polymerization reactor was 3,500 g per g of the catalyst.

The polyethylene powder (A) and a microporous membrane of the polyethylene powder (A) produced by the above [Method for producing microporous membrane] were variously evaluated as mentioned above. The results are shown in Table 5.

### Examples 12 to 20 and Comparative Examples 7, 8, 11, and 12

Each polyethylene powder and its microporous membrane were produced in the same manner as in Example 11 and variously evaluated as mentioned above except that the polymerization conditions were changed as shown in Tables 3 and 4. The results are shown in Tables 5 and 6. In Example 15 and Comparative Example 12, 0.05 mol % of 1-butene was copolymerized as a comonomer.

### Comparative Example 9

Hexane, ethylene, hydrogen, and a catalyst were continuously supplied to a vessel-type 300 L polymerization reactor equipped with a Fullzone stirring blade without a baffle. The partial pressure of ethylene for polymerization was 0.5 MPa. The polymerization temperature was kept at 75° C. by jacket cooling. Hexane was supplied at 40 L/hr from the bottom of the reactor, and an average residence time was 3 hours. The catalyst was mixed with 2 mmol of 1 M ethylaluminum dichloride added per g of the catalytic component (K) before being supplied to the polymerization reactor. Then, the supernatant was decanted and replaced with hexane. This preliminary treatment was performed three times, and the catalyst was then used. In a buffer tank before supply for polymerization, 20 mmol of triisobutylaluminum was mixed as a scavenger for impurities per g of the preliminarily treated catalytic component (K). The mixed catalytic component (K) was added at a rate of 0.2 g/hr to the reactor. Ethylene and hydrogen were introduced to the gas phase, and hydrogen was continuously supplied through a pump such that the hydrogen concentration based on ethylene in the gas phase was 5 mol %. The stirring speed was 230 rpm.

The reaction mixture was continuously discharged to a flash drum having a pressure of 0.05 MPa and a temperature of 70° C. such that the level of the polymerization reactor was kept constant to separate unreacted ethylene and hydrogen.

Next, the polymer slurry was continuously sent to a centrifuge such that the level of the polymerization reactor was kept constant to separate a polyethylene powder from the other materials such as the solvent.

The separated polyethylene powder was dried under nitrogen blow at 78° C. In this drying step, steam was sprayed to the powder thus polymerized to inactivate the catalyst and the co-catalyst. To the obtained polyethylene powder, 1,000 ppm of calcium stearate (manufactured by Dainichi Chemical Industry Co., Ltd., C60) was added and homogeneously mixed therewith using a Henchel mixer. The obtained polyethylene powder was sifted through a sieve having an opening of 425 μm, and particles that did not pass through the sieve were removed to obtain a polyethylene powder (K). Polymerization activity in the polymerization reactor was 20,000 g per g of the catalyst.

The polyethylene powder (K) and a microporous membrane of the polyethylene powder (K) produced by the above [Method for producing microporous membrane] were variously evaluated as mentioned above. The results are shown in Table 6.

### Comparative Example 10

Hexane, ethylene, hydrogen, and a catalyst were continuously supplied to a vessel-type 300 L polymerization reactor equipped with a stirrer. The polymerization pressure was 0.35 MPa. The polymerization temperature was kept at 75° C. by jacket cooling. Hexane was supplied at 40 L/hr from the bottom of the reactor, and an average residence time was 3 hours. The catalyst used was the catalytic component (L), and the scavenger for impurities used was triisobutylaluminum. Triisobutylaluminum was added to the reactor at a rate of 10 mmol/h. The catalytic component (L) was supplied thereto at a rate of 0.2 g/hr. Hydrogen was continuously supplied thereto through a pump such that the gas-phase concentration was 2000 ppm. The stirring speed was 230 rpm. A hexane solution containing 100 mmol/L normal butanol was supplied thereto such that the amount of normal butanol was 1 ppm/h based on a polymerization rate (production rate) of 10 kg/h to obtain polymer slurry. The obtained polymer slurry was sent to a centrifuge to separate a polyethylene powder from the other materials such as the solvent. Then, the polyethylene powder was contacted with methanol of 60° C. for 1 hour with stirring. The polymer slurry containing the polyethylene powder and methanol was sent to a centrifuge to separate the polyethylene powder from the other materials such as the solvent. The separated polyethylene powder was dried under nitrogen blow at 70° C. The polyethylene powder thus obtained was sifted through a sieve having an opening of 425 μm, and particles that did not pass through the sieve were removed to obtain a polyethylene powder (L). Polymerization activity in the polymerization reactor was 30,000 g per g of the catalyst.

The polyethylene powder (L) and a microporous membrane of the polyethylene powder (L) produced by the above [Method for producing microporous membrane] were variously evaluated as mentioned above. The results are shown in Table 6.

TABLE 3

| | | | Example | Example | Example | Example | Example | Example | Example | Example | Example | Example |
|---|---|---|---|---|---|---|---|---|---|---|---|---|
| | | | 11 | 12 | 13 | 14 | 15 | 16 | 17 | 18 | 19 | 20 |
| Polymerization | Catalyst species | | A | B | C | D | E | F | G | H | N | O |
| conditions | Polymerization | L | 1.5 | 1.5 | 1.5 | 1.5 | 1.5 | 1.5 | 1.5 | 1.5 | 1.5 | 1.5 |
| | reactor | | | | | | | | | | | |
| | capacity | | | | | | | | | | | |
| | Amount of | μmol | 1.25 | 1.25 | 1.25 | 1.25 | 1.25 | 1.25 | 1.25 | 1.25 | 1.25 | 1.25 |
| | catalyst added | (Ti/Zr) | | | | | | | | | | |
| | Temperature | ° C. | 60 | 60 | 60 | 60 | 60 | 60 | 60 | 60 | 75 | 75 |
| | Pressure | MPa/G | 0.65 | 0.65 | 0.65 | 0.65 | 0.65 | 0.65 | 0.65 | 0.65 | 0.65 | 0.65 |
| | Stirring speed | rpm | 1200 | 1200 | 1200 | 1200 | 1200 | 1200 | 1200 | 1200 | 1200 | 1200 |
| | Amount of | mL | 800 | 800 | 800 | 800 | 800 | 800 | 800 | 800 | 800 | 800 |
| | solvent | | | | | | | | | | | |
| | Scavenger | — | d-1 | d-1 | d-1 | d-1 | d-1 | d-1 | d-1 | d-1 | Et₃Al | Et₃Al |
| | species | | | | | | | | | | | |
| | Scavenger | mmol | 0.4 | 0.4 | 0.4 | 0.4 | 0.4 | 0.4 | 0.4 | 0.4 | 0.4 | 0.4 |
| | concentration | | | | | | | | | | | |
| | Time | h | 0.5 | 0.5 | 0.5 | 0.5 | 0.5 | 0.5 | 0.5 | 0.5 | 1 | 1 |
| | Hydrogen | mL/L | 0.5 | 0.5 | 0.26 | 0.5 | 0.26 | 0.5 | 0.5 | 0.5 | 2.5 | 2.5 |
| | | ethylene | | | | | | | | | | |
| | Comonomer | mol % | 0 | 0 | 0 | 0 | 0.05 | 0 | 0 | 0 | 0 | 0 |
| | Activity | g/(gs) | 3500 | 2800 | 4200 | 2400 | 3100 | 3000 | 3400 | 3800 | 13500 | 15000 |

TABLE 4

| | | | Comparative | Comparative | Comparative | Comparative | Comparative | Comparative |
|---|---|---|---|---|---|---|---|---|
| | | | Example 7 | Example 8 | Example 9 | Example 10 | Example 11 | Example 12 |
| Polymerization | Catalyst species | | I | J | K | L | M | E′ |
| conditions | Polymerization | L | 1.5 | 1.5 | 300 | 300 | 1.5 | 1.5 |
| | reactor | | | | | | | |
| | capacity | | | | | | | |
| | Amount of | μmol (Ti/Zr) | 1.25 | 9 | 0.2 g/h | 0.2 g/h | 1.25 | 1.25 |
| | catalyst added | | | | | | | |
| | Temperature | ° C. | 60 | 78 | 75 | 75 | 60 | 60 |
| | Pressure | MPa/G | 0.65 | 0.3 | 0.5 | 0.35 | 0.65 | 0.65 |
| | Stirring speed | rpm | 1200 | 1200 | 230 | 230 | 1200 | 1200 |
| | Amount of | mL | 800 | 800 | 40 L/h | 40 L/h | 800 | 800 |
| | solvent | | | | | | | |
| | Scavenger | — | d-1 | iBu₃Al | iBu₃Al | iBu₃Al | d-1 | d-1 |
| | species | | | | | | | |
| | Scavenger | mmol | 0.4 | 0.4 | 4 mmol/h | 10 mmol/h | 0.4 | 0.4 |
| | concentration | | | | | | | |
| | Time | h | 0.5 | 1 | 3 | 3 | 0.5 | 0.5 |
| | Hydrogen | mL/L ethylene | 1.3 | 10 mol % | 5 mol % | 2000 ppm | 1.3 | 0.5 |
| | Comonomer | mol % | 0 | 0 | 0 | 0 | 0 | 0.05 |
| | Activity | g/(gs) | 5000 | 15000 | 20000 | 30000 | 5500 | 3000 |

In Tables 3 and 4, d-1 represents the organic metal compound component (d-1) synthesized as described above; Et₃Al represents triethylaluminum; and iBu₃Al represents triisobutylaluminum.

TABLE 5

| | | Example | Example | Example | Example | Example | Example | Example | Example | Example | Example |
|---|---|---|---|---|---|---|---|---|---|---|---|
| | | 11 | 12 | 13 | 14 | 15 | 16 | 17 | 18 | 19 | 20 |
| Polyethylene | Crystal thickness parameter | 7.1 | 6.9 | 6.1 | 8.1 | 5.9 | 6.2 | 6.5 | 5.8 | 6.5 | 5.8 |
| powder | GPC-Visco | 0.916 | 0.985 | 0.988 | 0.81 | 0.99 | 0.995 | 0.67 | 0.69 | 0.67 | 0.69 |
| | z-Average contraction factor | | | | | | | | | | |
| | g_{z} | | | | | | | | | | |
| | Viscosity-average molecular | 50 | 40 | 90 | 140 | 90 | 40 | 250 | 40 | 250 | 40 |
| | weight Mv (×10000) | | | | | | | | | | |
| | Drawability evaluation | ◯ | ◯ | ◯ | ◯ | ◯ | ◯ | ◯ | ◯ | ◯ | ◯ |
| | Absorption coefficient at 400 | 2.2-2.4 | 2.3-2.5 | 2.2-2.4 | 2.4-2.6 | 2.3-2.5 | 2.0-2.2 | 2.2-2.4 | 2.2-2.4 | 1.9-2.1 | 1.9-2.1 |
| | to 450 cm⁻¹ | | | | | | | | | | |
| | Presence or absence of peak | Absent | Absent | Absent | Absent | Absent | Absent | Absent | Present | Absent | Present |
| | in ¹H-NMR | | | | | | | | | | |
| | Al content (ppm) | 13 | 12 | 6 | 43 | 16 | 3 | 45 | 85 | 45 | 85 |
| | Si content (ppm) | 2 | 2 | 1 | 2 | 2 | 70 | 2 | 2 | 1 | 1 |
| | Tm2ₜₒₚ (° C.) | 136.6 | 136.3 | 135.9 | 135.4 | 132.2 | 136.3 | 135.6 | 135.4 | 135.6 | 135.4 |
| | Density (kg/m³) | 941 | 943 | 939 | 934 | 932 | 944 | 928 | 938 | 928 | 938 |
| Microporous | Heat resistance | ⊚ | ⊚ | ⊚ | ⊚ | ◯ | ◯ | ◯ | ◯ | ◯ | ⊚ |
| membrane | Homogeneity | ⊚ | ◯ | ◯ | ⊚ | ◯ | ◯ | ⊚ | ⊚ | ⊚ | ⊚ |
| | Dimensional stability | ⊚ | ⊚ | ⊚ | ◯ | ◯ | ⊚ | ◯ | ◯ | ⊚ | ◯ |
| | Rate of enhancement in heat | ⊚ | ⊚ | ◯ | ⊚ | ◯ | ◯ | ◯ | ◯ | ◯ | ⊚ |
| | resistance | | | | | | | | | | |

TABLE 6

| | | Comparative | Comparative | Comparative | Comparative | Comparative | Comparative |
|---|---|---|---|---|---|---|---|
| | | Example 7 | Example 8 | Example 9 | Example 10 | Example 11 | Example 12 |
| Polyethylene | Crystal thickness | 4.8 | 4.7 | 4.7 | 4.5 | 4.3 | 4.6 |
| powder | parameter | | | | | | |
| | GPC-Visco | 0.57 | 1 | 1 | 1 | 0.58 | 1 |
| | z-Average contraction | | | | | | |
| | factor g_{z} | | | | | | |
| | Viscosity-average | 10 | 50 | 90 | 200 | 15 | 40 |
| | molecular weight Mv | | | | | | |
| | (×10000) | | | | | | |
| | Drawability evaluation | ◯ | ◯ | ◯ | ◯ | ◯ | ◯ |
| | Absorption coefficient at | 2.0-2.2 | 1.8-2.0 | 1.6-1.8 | 1.6-1.8 | 2.0-2.2 | 2.3-2.5 |
| | 400 to 450 cm⁻¹ | | | | | | |
| | Presence or absence of | Present | Present | Present | Present | Present | Present |
| | peak in ¹H-NMR | | | | | | |
| | Al content (ppm) | 92 | 3 | 2 | 6 | 150 | 16 |
| | Si content (ppm) | 55 | 1 | 1 | 0.5 | 58 | 3 |
| | Tm2ₜₒₚ (° C.) | 134.6 | 135.9 | 136.3 | 136.4 | 134.8 | 132.5 |
| | Density (kg/m³) | 953 | 943 | 939 | 932 | 952 | 933 |
| Microporous | Heat resistance | x | x | x | ○ | x | x |
| membrane | Homogeneity | x | x | x | x | x | x |
| | Dimensional stability | x | ○ | ○ | x | x | x |
| | Rate of enhancement in | x | x | x | x | x | x |
| | heat resistance | | | | | | |

The present application is based on Japanese Patent Application No. 2022-059266 filed on Mar. 31, 2022, the contents of which are incorporated herein by reference in their entirety.

### INDUSTRIAL APPLICABILITY

The polyethylene powder of the present invention is excellent in heat resistance, membrane homogeneity, dimensional stability, and a rate of enhancement in heat resistance in the form of a microporous membrane, for example, and has industrial applicability.

1: A polyethylene powder
having a viscosity-average molecular weight of 100,000 or larger and 4,000,000 or smaller, and
having a crystal thickness parameter of 5° C. or higher and 9° C. or lower obtained from measurement using a differential scanning calorimeter (DSC).

2: The polyethylene powder according to claim 1, wherein a value of z-average shrinkage factor g_{z} measured using a gel permeation chromatography (GPC) measurement apparatus combined with a differential refractometer and a viscosity detector is 0.600 or more and 1 or less.

3: The polyethylene powder according to claim 1, wherein a peak top temperature (Tm2ₜₒₚ) in a DSC curve of a second heating process obtained by measurement shown in the following <Measurement conditions> using a differential scanning calorimeter (DSC) is 135° C. or higher and 140° C. or lower:
<Measurement conditions>
(1) left standing at 50° C. for 1 min,
(2) heated from 50° C. to 180° C. at 10° C./min (first heating process),
(3) left standing at 180° C. for 5 min,
(4) cooled from 180° C. to 50° C. at 10° C./min,
(5) left standing at 50° C. for 5 min, and
(6) heated from 50° C. to 180° C. at 10° C./min (second heating process), and
the crystal thickness parameter is 6.7° C. or higher and 9.0° C. or lower.

4: The polyethylene powder according to claim 2, wherein the polyethylene powder is drawable under the following conditions:
(Drawing conditions)
a 100 mm×100 mm×1 mm thick gel sheet made of 30% by mass of the polyethylene powder and 70% by mass of liquid paraffin is drawn at a ratio of 7×7 at 115° C.

5: The polyethylene powder according to claim 2, wherein an absorption coefficient at 400 cm⁻¹ to 450 cm⁻¹ in terahertz measurement is 1.0 or more and 4.0 or less.

6: The polyethylene powder according to claim 2, wherein no peak is present in the following regions in ¹H-NMR measurement:
(1) 4.8 ppm to 5.0 ppm, and
(2) 5.6 ppm to 6.0 ppm.

7: The polyethylene powder according to claim 2, wherein an aluminum content is 0 ppm or more and 50 ppm or less.

8: The polyethylene powder according to claim 2, wherein a silicon content is 0 ppm or more and 30 ppm or less.

9: The polyethylene powder according to claim 2, wherein a peak top temperature in a DSC curve of a second heating process in differential scanning calorimeter (DSC) measurement is 130° C. or higher and 140° C. or lower.

10: The polyethylene powder according to claim 2, wherein a density is 920 kg/m³ or more and 960 kg/m³ or less.

11: The polyethylene powder according to claim 2 for a battery separator.

12: A method for producing a catalyst for olefin polymerization, comprising:
a first supporting reaction step of reacting a solid particle [A] with a transition metal compound component [B-1] and/or a transition metal compound component [B-2] and an activating agent [C] and/or an organic metal compound component [D]; and
a second supporting reaction step of reacting the particle obtained in the first supporting reaction step with the transition metal compound component [B-1] and/or the transition metal compound component [B-2] and the activating agent [C] and/or the organic metal compound component [D], wherein
the transition metal compound component [B-1] is a compound represented by the following (Formula 3), the transition metal compound component [B-2] is a compound represented by the following (Formula 4), the activating agent [C] is a compound represented by the following (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table, and
the following <Condition 1> and/or <Condition 2> is satisfied:
<Condition 1>
the first supporting reaction step comprises: a premixing step of reacting the transition metal compound component [B-1] and/or the transition metal compound component [B-2] with the activating agent [C] and/or the organic metal compound component [D]; and the step of reacting the solid particle [A] with the mixture obtained in the premixing step,
<Condition 2>
in the first supporting reaction step, a molar ratio (([C]+[D])/[B]) of a molar quantity ([C]+[D]) of the activating agent [C] and the organic metal compound component [D] to a molar quantity [B] of the transition metal compound component [B-1] and/or the transition metal compound component [B-2] is 1 or more and 60 or less,
L¹ⱼWₖM¹X¹ₚX²_{q} (Formula 3)
wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3, or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic σ-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2, 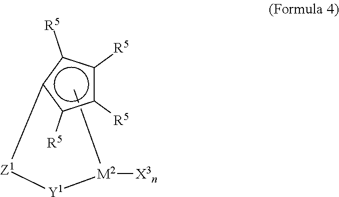
wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,
(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d,
(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.

13: The method for producing a catalyst for olefin polymerization according to claim 12, wherein the solid particle [A] is a magnesium chloride particle.

14: A catalyst for olefin polymerization, comprising
a solid particle [A], a transition metal compound component [B-1] and/or a transition metal compound component [B-2], and an activating agent [C] and/or an organic metal compound component [D], wherein
the transition metal compound component [B-1] is a compound represented by the following (Formula 3), the transition metal compound component [B-2] is a compound represented by the following (Formula 4), the activating agent [C] is a compound represented by the following (Formula 5) or (Formula 6), the organic metal compound component [D] is a compound containing at least one metal selected from the group consisting of group 1, group 2, group 12, and group 13 of the periodic table, and the solid particle [A] is a porous polymer material or an inorganic solid particle containing at least one element selected from the group consisting of group 2 to group 4, group 13, and group 14 of the periodic table,
a content (mol) of a central metal M contained in the transition metal compound component [B-1] and/or the transition metal compound component [B-2] is 20 μmol or more and 1000 μmol or less, and a molar ratio (AI/M) of a content (mol) of Al to the content (mol) of the central metal M is 1 or more and 30 or less:
L¹ⱼWₖM¹X¹ₚX²_{q} (Formula 3)
wherein
each L¹ independently represents a η-binding cyclic anion ligand selected from the group consisting of a cyclopentadienyl group, an indenyl group, a tetrahydroindenyl group, a fluorenyl group, a tetrahydrofluorenyl group, and an octahydrofluorenyl group, and the ligand optionally has 1 to 8 substituents, wherein the substituents are each independently a substituent having up to 20 non-hydrogen atoms selected from the group consisting of a hydrocarbon group having 1 to 20 carbon atoms, a halogen atom, a halogen-substituted hydrocarbon group having 1 to 12 carbon atoms, an aminohydrocarbyl group having 1 to 12 carbon atoms, a hydrocarbyloxy group having 1 to 12 carbon atoms, a dihydrocarbylamino group having 1 to 12 carbon atoms, a hydrocarbylphosphino group having 1 to 12 carbon atoms, a silyl group, an aminosilyl group, a hydrocarbyloxysilyl group having 1 to 12 carbon atoms, and a halosilyl group,
M¹ is a transition metal with a formal oxidation number of +2, +3 or +4 selected from a transition metal group belonging to group 4 of the periodic table and represents a transition metal η5-bonded to at least one ligand L¹,
W is a divalent substituent having up to 50 non-hydrogen atoms and represents a divalent substituent that is bonded to L¹ and M¹ with respective valences of 1, thereby forming a metallocycle in cooperation with L¹ and M¹,
each X¹ independently represents an anionic σ-binding ligand having up to 60 non-hydrogen atoms selected from the group consisting of a monovalent anionic σ-binding ligand, a divalent anionic σ-binding ligand bonded to M¹ with divalence, and a divalent anionic σ-binding ligand bonded to L¹ and M¹ with respective valences of 1,
each X² independently represents a neutral Lewis base-coordinating compound having up to 40 non-hydrogen atoms,
j is 1 or 2, provided that when j is 2, two ligands L¹ are optionally bonded to each other via a divalent group having up to 20 non-hydrogen atoms, wherein the divalent group is a group selected from the group consisting of a hydrocarbadiyl group having 1 to 20 carbon atoms, a halohydrocarbadiyl group having 1 to 12 carbon atoms, a hydrocarbyleneoxy group having 1 to 12 carbon atoms, a hydrocarbyleneamino group having 1 to 12 carbon atoms, a silanediyl group, a halosilanediyl group, and a silyleneamino group, k is 0 or 1, p is 0, 1, or 2, provided that when X¹ is a monovalent anionic σ-binding ligand, or a divalent anionic σ-binding ligand bonded to L¹ and M¹, p is an integer smaller by 1 or more than the formal oxidation number of M¹, when X¹ is a divalent anionic σ-binding ligand bonded only to M¹, p is an integer smaller by (j+1) or more than the formal oxidation number of M¹, and q is 0, 1, or 2, 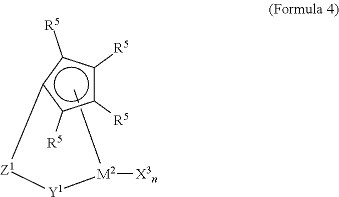
wherein
M² is a transition metal selected from the group consisting of titanium, zirconium, and hafnium and represents a transition metal with a formal oxidation number of +2, +3, or +4,
each R⁵ independently represents a hydrogen atom or a substituent having 1 to 20 non-hydrogen atoms selected from the group consisting of a hydrocarbon group having 1 to 8 carbon atoms, a silyl group, a germyl group, a cyano group, a halogen atom, and a complex group thereof, provided that when the substituent R⁵ is a hydrocarbon group having 1 to 8 carbon atoms, a silyl group, or a germyl group, two adjacent substituents R⁵ are optionally bonded to each other to form a divalent group, thereby forming a ring in cooperation with a bond between two carbon atoms of a cyclopentadienyl ring bonded to the two adjacent substituents R⁵, respectively,
each X³ independently represents a substituent having 1 to 20 non-hydrogen atoms selected from the group consisting of halide, a hydrocarbon group having 1 to 20 carbon atoms, a hydrocarbyloxy group having 1 to 18 carbon atoms, a hydrocarbylamino group having 1 to 18 carbon atoms, a silyl group, a hydrocarbylamide group having 1 to 18 carbon atoms, a hydrocarbyl phosphide group having 1 to 18 carbon atoms, a hydrocarbyl sulfide group having 1 to 18 carbon atoms, and a complex group thereof, provided that two substituents X³ optionally form neutral conjugated diene or a divalent group having 4 to 30 carbon atoms in cooperation,
Y¹ represents —O—, —S—, —NR⁶—, or —PR⁶—, wherein R⁶ represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a complex group thereof,
Z¹ represents SiR⁶₂, CR⁶₂, SiR⁶₂SiR⁶₂, CR⁶₂CR⁶₂, CR⁶═CR⁶, CR⁶₂SiR⁶₂, or GeR⁶₂, wherein R⁶ is as defined above, and
n is 1, 2, or 3,
(C-1):[L²-H]^{d+}[M³ᵣQₛ]^{d-} (Formula 5)
wherein [L²-H]^{d+} is a proton-donating Bronsted acid, L² is a neutral Lewis base; [M³ᵣQₛ]^{d-} in the formula is a compatible non-coordinating anion, M³ is a metal or a metalloid selected from group 5 to group 15 of the periodic table, each Q is independently hydride, a dialkylamide group, halide, an alkoxide group, an allyloxide group, a hydrocarbon group, or a substituted hydrocarbon group having up to 20 carbon atoms, and the number of halides Q is 1 or less; r is an integer of 1 to 7, s is an integer of 2 to 14, d is an integer of 1 to 7, and s−r=d,
(C-2):-(M⁴R⁷ₜ₋₂—O)ᵤ— (Formula 6)
wherein M⁴ is a metal or a metalloid of group 13 to group 15 of the periodic table, each R⁷ is independently a hydrocarbon group or a substituted hydrocarbon group having 1 to 12 carbon atoms, t is the valence of the metal M⁴, and u is an integer of 2 or larger.

15: The catalyst for olefin polymerization according to claim 14, wherein the solid particle [A] is a magnesium chloride particle.

16: A method for producing an olefin polymer, comprising the step of polymerizing olefin using the catalyst for olefin polymerization according to claim 14.

17: The polyethylene powder according to claim 3, wherein the polyethylene powder is drawable under the following conditions:
(Drawing conditions)
a 100 mm×100 mm×1 mm thick gel sheet made of 30% by mass of the polyethylene powder and 70% by mass of liquid paraffin is drawn at a ratio of 7×7 at 115° C.

18: The polyethylene powder according to claim 3, wherein an absorption coefficient at 400 cm⁻¹ to 450 cm⁻¹ in terahertz measurement is 1.0 or more and 4.0 or less.

19: The polyethylene powder according to claim 3, wherein no peak is present in the following regions in ¹H-NMR measurement:
(1) 4.8 ppm to 5.0 ppm, and
(2) 5.6 ppm to 6.0 ppm.

20: The polyethylene powder according to claim 3, wherein an aluminum content is 0 ppm or more and 50 ppm or less.
